(19) United States
(12) Patent Application Publication
(10) Pub. No.: US 2006/0210903 A1
(43) Pub. Date: Sep. 21, 2006

(54) Toner, developer, toner container, process cartridge, image forming apparatus and image forming method

(76) Inventors: Masahiro Ohki, Numazu-shi (JP); Naohiro Watanabe, Sunto-gun (JP); Ryota Inoue, Mishima-shi (JP); Akinori Saitoh, Numazu-shi (JP); Shigeru Emoto, Numazu-shi (JP); Masahide Yamada, Numazu-shi (JP); Chiaki Tanaka, Izunokuni-shi (JP); Tsunemi Sugiyama, Kashiwa-shi (JP); Yohichiroh Watanabe, Fuji-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/375,050

(22) Filed: Mar. 15, 2006

(30) Foreign Application Priority Data
Mar. 16, 2005 (JP) 2005-074453
Mar. 16, 2005 (JP) 2005-075234

(51) Int. Cl. G03G 9/087; G03G 9/09

(52) U.S. Cl. 430/109.4; 430/111.4

(57) ABSTRACT

The present invention provides a toner and a developer which includes the toner. The toner is produced in an aqueous medium and includes at least a binding resin, a colorant and a dispersant which disperses the colorant. The binding resin contains 50% by mass to 100% by mass of a polyester resin, and the colorant is a pigment whose surface is given an acid treatment. The acid value of the dispersant is 1 mg KOH/g to 30 mg KOH/g, and the amine value of the dispersant is 1 mg KOH/g to 100 mg KOH/g.

### BACKGROUND OF THE INVENTION

1. Field of the Invention

The present invention relates to: a toner for image formation which has a superior charge property, flowability, stability and transfer property, has a favorable charge property as well as favorable image quality, and is able to form an image with superior OHP optical transparency; a developer using the toner; a toner container; a process cartridge; an image forming apparatus; and an image forming method.

2. Description of the Related Art

In an electrophotographic apparatus and an electrostatic recording apparatus, an electric latent image or a magnetic latent image have been developed by a toner. In the electrophotographic method, for example, the formation of the electrostatic image latent image) is followed by the development of the latent image with a toner to form a toner image. The toner image is commonly transferred on a transfer member such as paper and then fixed by heating, for example. The toner used for developing the electrostatic image is generally colored particles which include a colorant, a charge controller and other additives in a binding resin, and there are mainly two toner manufacturing techniques, namely the grinding technique and the suspension polymerization technique. In the grinding technique, a colorant, a charge controller and an offset inhibitor are melted and mixed to form a uniform dispersion, which is then grinded and classified to produce a toner.

The grinding technique may produce a toner with a certain level of superior properties, but there are limitations of the selection of toner materials. For example, a composition obtained by melt-mixing must sustain grinding and classification in an economically feasible apparatus. Because of this criterion, the composition obtained by melt-mixing is forced to be sufficiently fragile. Therefore, when in practice a copying image which enables an easy formation of a wide particle size distribution and produces favorable resolution and tone in grinding the composition particles, a fine powder of less than 3 μm in size and a coarse grain of more than 20 μm in size must be removed by classification, which disadvantageously reduces the yield. Also, in the grinding technique, it is difficult to disperse uniformly the colorant and the charge controller in a thermoplastic resin. In addition, since the colorant added to the toner is exposed on the toner surface, there is a problem that the charge on the toner surface is unstable, widening the charge distribution of the toner and degrading the developing properties. Therefore, because of these problems, the kneading and grinding technique is currently unable to meet the demand for increased performance.

Recently, in order to resolve these problems in the grinding technique, a toner manufacturing method by the suspension polymerization technique has been proposed and implemented. The technology for manufacturing a toner for developing a latent electrostatic image by the polymerization method is heretofore known, and toner particles are produced by, for example, the suspension polymerization method. However, the shape of a toner particles obtained by the suspension polymerization method is spherical, which is disadvantageous for its inferior cleaning property. Insufficient cleaning is not a problem in the development and transfer with low image area ratio since the amount of residual toner is small. On the other hand, an electrophotographic image has a high image area ratio, and there are occasions where an image forming toner which is yet to be transferred remains on a photoconductor as a residual toner due to, for example, paper feeding failure. The residual toner accumulates to cause a background smear of an image.

In addition, the residual toner contaminates the charge roller which contacts and charges the photoconductor, inhibiting the intrinsic charging ability. Moreover, many materials used conventionally for a toner may not be used since the toner preparation is performed simultaneously with the polymerization of a resin. Even though a conventionally-used material is polymerizable, there are cases that the particle size may not be sufficiently controlled due to the effect of the additives such as resin and colorant. Therefore, this technique has a problem of less flexibility in the selection of a material.

In particular, a problem lies in the inability to use a polyester resin which has conventionally been used for developing superior fixing property and coloring property in the kneading and grinding method as well as to comply with downsizing, speeding up and colorization to a satisfactory degree. Because of this, Japanese Patent (JP-B) No. 2537503 discloses a method for obtaining toner particles with an irregular form by associating resin particles obtained by the emulsion polymerization method.

However, the toner particles obtained by the emulsion polymerization method have a large quantity of surfactant remaining not only on the surface but also the inside of the particles even after a water-washing process, which impairs the stability of the toner charging environment and widen the charge distribution to cause a defect of background smear of the obtained image. Also, the residual surfactant contaminates the photoconductor, the charge roller and the developing roller, inhibiting the intrinsic charge ability. In addition, even in the emulsion polymerization method in which the colorant component is merely exposed on the toner surface, it is difficult to uniformly add and disperse the colorant in the toner due to the easy agglomeration of the colorant, causing variations among toners in the way the colorant disperses, which results in the nonuniformity of the charge and the stability reduction with time. Moreover, slight degradation of the developing property and the transferring property in color output causes problematic degradation in the color balance and the tone. Furthermore, since the colorant in the toner is in general hydrophilic and mutually insoluble with a resin, the transmitted light reflects diffusely at the boundary, inhibiting the OHP transparency. Therefore, there is also a problem that the insufficient dispersion of the colorant reduces the OHP transparency.

Also, Japanese Patent Application Laid-Open (JP-A) No. 2001-66827 discloses: a process for preparing a pigment dispersion by dissolving and/or dispersing a pigment, whose surface has been treated with a fatty acid, and a pigment dispersant in a first organic solvent which solubilizes a binding resin; a process for preparing an oil-based component by mixing a binding resin and the pigment dispersant in a second organic solvent which solubilizes the binding resin; a process for suspending the oil-based component in an aqueous medium for refinement; and a toner obtained by removing the solvent from the obtained suspension. However, the fatty acid does not include an amino group which controls the charge property of a toner.

Especially, a color output machine of the standard practice requires no oil supply apparatus for a fixing unit and uses an oilless toner which contains a releasing agent as a substitute of oil in the toner. However, since the releasing agent cannot be refined as much as a colorant, uniform addition and dispersion is more difficult. There is also a problem that poor dispersion of the releasing agent inhibits the charge property, developing property, storage stability and OHP transparency. As described above, a toner for electrophotography which is able to meet the demand for higher performance and related technologies thereof have not yet been achieved.

### SUMMARY OF THE INVENTION

The present invention is aimed at providing a toner with a superior offset property, charge property and storage stability as well as favorable coloring property and OHP transparency in order to meet the demand for higher performance by improving the dispersibility of a colorant and a releasing agent in the toner and by giving an acid treatment to the pigment surface; a developer using the toner as a means to avoid the degradation in the charge property in case of using a pigment dispersant having an amine value; a toner container; a process cartridge; an image forming apparatus; and an image forming method.

Keen examinations by the inventors resulted in the following insight. That is, the use of a pigment dispersant whose surface is given an acid treatment to have a predetermined acid value and amine value for a toner manufactured by the liquid medium method enhances the dispersion and the dispersion stability of the colorant as well as the control of the charge property.

A toner of the present invention is produced in an aqueous medium and includes at least a binding resin, a colorant and a dispersant which disperses the colorant,

where the binding resin contains 50% by mass to 100% by mass of a polyester resin;

the colorant is a pigment whose surface is given an acid treatment; and

the acid value of the dispersant is 1 mg KOH/g to 30 mg KOH/g, and the amine value of the dispersant is 1 mg KOH/g to 100 mg KOH/g.

A developer of the present invention includes the toner of the present invention.

A toner container of the present invention is filled with the toner of the present invention.

A process cartridge includes at least a latent electrostatic image bearing member and a developing means to develop a latent electrostatic image formed on the latent electrostatic image bearing member using the toner of the present invention and to form a visible image.

An image forming apparatus of the present invention includes at least a latent electrostatic image bearing member, a latent electrostatic image forming means which forms a latent electrostatic image on the latent electrostatic image bearing member, a developing means which forms a visible image by developing the latent electrostatic image using the toner of the present invention, a transferring means which transfers the visible image to a recording medium, and a fixing means which fixes a transfer image transferred to the recording medium.

An image forming method of the present invention includes at least a latent electrostatic image forming process which forms a latent electrostatic image on a latent electrostatic image bearing member, a developing process which forms a visible image by developing the latent electrostatic image using the toner of the present invention, a transferring process which transfers the visible image to a recording medium, a fixing process which fixes a transfer image transferred to the recording medium.

### BRIEF DESCRIPTION OF THE DRAWINGS

FIG. 1 is a schematic diagram showing an example of a process cartridge of the present invention.

FIG. 2 is a schematic diagram showing one exemplary implementation of an image forming method of the present invention by means of an image forming apparatus of the present invention.

FIG. 3 is a schematic diagram showing another exemplary implementation of an image forming method of the present invention by means of an image forming apparatus of the present invention.

FIG. 4 is a schematic diagram showing an exemplary implementation of an image forming method of the present invention by means of an image forming apparatus of the present invention (tandem color image forming apparatus).

FIG. 5 is a partially-enlarged schematic diagram of the image forming apparatus shown in FIG. 4.

### DESCRIPTION OF THE PREFERRED EMBODIMENTS

(Toner)

A toner of the present invention is produced in an aqueous medium; it includes at least a binding resin, a colorant and a dispersant to disperse the colorant, and it further includes other components according to requirements.

The binding resin contains 50% by mass to 100% by mass of a polyester resin;

the colorant is a pigment whose surface is given an acid treatment; and

the acid value of the dispersant is 1 mg KOH/g to 30 mg KOH/g, and the amine value of the dispersant is 1 mg KOH/g to 100 mg KOH/g.

The colorant used in the present invention can control the pigment dispersibility and the charge stability owing to the surface treatment. Examples of a surface treatment agent include natural rosin such as gum rosin, wood rosin and tall rosin; an abietic acid derivative such as abietic acid, levopimaric acid and dextropimaric acid, and a metal salts thereof such as calcium salt, sodium salt, potassium salt and magnesium salt; a rosin-modified maleic resin; and a rosin-modified phenolic resin. In particular, an acid surface treatment is preferably used to enhance the affinity with a pigment dispersant and to control the charge property. The amount of the surface treatment agent added to the colorant is, with respect to the amount of the colorant, 0.1% by mass to 100% by mass, and more preferably 0.1% by mass to 10% by mass.

The dispersant used in the present invention can enhance the affinity of the dispersant and the binding agent and can suitably balance the polar part and the nonpolar part by maintaining the acid value and the amino value within a certain range. Because of this, when the dispersant used in the present invention is added, an amine site of the dispersant is adsorbed to an acid site on the pigment surface. Exposure of the acid site of the dispersant on the surface presumably allows the control of the charge property of the toner, exertion of high dispersion power to a colorant, resin and solvent, and improvement of the dispersibility and dispersion stability of the colorant as well as the flowability of the toner.

Regarding a dispersion resin favorably used for further dispersion of the surface-treated pigment of the present invention, examples thereof include a lime rosin varnish, a polyamide resin varnish or a vinyl chloride resin varnish, nitrocellulose lacquer, an amino-alkyd resin, a urethane resin and an acrylic resin. The added amount of the dispersion resin is, with respect to the amount of the colorant, preferably 0.1% by mass to 100% by mass, and more preferably 0.1% by mass to 20% by mass.

In other words, regarding the toner for electrophotography of the present invention, the acid treatment on the pigment surface for maintaining the acid value and the amine value of a dispersant within a certain range improves the dispersibility of the colorant, which consequently improves the coloring property of the toner and the OHP optical transparency. It increases the efficiency of the particle preparation in manufacturing as well since the colorant may be stably dispersed for a long period of time. Furthermore, it becomes possible to control the charge property, which is a negative effect of using a dispersant.

In particular, by manufacturing using the dispersant of the present invention having an acid value and an amine value within certain ranges, a pigment which has been given an acid treatment on the pigment surface and the dispersion resin, the colorant particles disperse uniformly within toner particles because of the differences in the affinity between the colorant and an oil-phase component and between the colorant and an aqueous medium, which consequently reduces the exposed amount of the colorant on the toner surface. Also, it offers broad options of the resin and the colorant, and it is possible to prevent the disintegration of the pigment dispersion system caused by introducing other additives such as wax. Furthermore, it allows the control of the shapes, and it becomes easy to make the particles spherical. Therefore, the toner obtained by this manufacturing method has the superior charge property, flowability, stability and transfer property. In other words, by applying the toner of the present invention to the developer for electrophotography, an image with the favorable charge property, favorable image quality and superior OHP optical transparency may be formed.

In addition, according to the present invention, 50% by mass to 100% by mass of the binding resin in the toner is a polyester resin. Setting the polyester resin composition in the toner binding resin to 50% by mass to 100% by mass allows the development of a superior fixing performance and color suitability which have been achieved by the kneading and grinding method; therefore, it is possible to sufficiently respond to speeding up and colorization. Examples of the polyester resin include all the polyester resins such as modified polyester resin, non-modified polyester resin and low molecular weight polyester. The total of these components accounts for 50% by mass to 100% by mass, and more preferably 75% by mass to 100% by mass, of the binding resin.

The toner of the present invention is produced in an aqueous medium, and it is a toner that includes at least the binding resin, the colorant and a modified polyurethane dispersant. The toner is typically produced by the following process: at least a component including an active hydrogen group, a polymer having a part which can react with active hydrogen, a colorant and a releasing agent are dissolved or dispersed in an organic solvent; and the solution or the dispersion is dispersed into droplets in an aqueous medium to form an O/W dispersion; during or after the reaction of the polymer having a part which can react with active hydrogen in the O/W dispersion, the organic solvent is removed followed by washing and drying. This image forming toner is explained hereinafter in more detail.

Organic Solvent

The organic solvent of the present invention is not restricted as long as it can dissolve and/or disperse the toner composition. The solvent is preferably volatile having a boiling point of less than 150° C. in view of easy removal. Examples of the solvent include a water-insoluble organic solvent such as toluene, xylene, benzene, carbon tetrachloride, methylene chloride, 1,2-dichloroethane, 1,1,2-trichloroethane, trichloroethylene, chloroform, monochlorobenzene, methyl acetate and ethyl acetate. These may be used alone or in combination of two or more. Furthermore, methyl ethyl ketone, acetone, tetrahydrofuran, dioxane, dimethylformamide, methylcellosolve, methanol, ethanol and isopropanol may be used alone or in combination of two or more. The amount of the solvent used is, with respect to 100 parts of the toner composition, usually 40 parts to 300 parts, preferably 60 parts to 140 parts, and more preferably 80 parts to 120 parts.

Modified Polyester Resin

Any heretofore known active hydrogen and reactive group in the modified polyester resin may be used, and it is preferably an isocyanate group, an epoxy group, a carboxylic acid and an acid chloride group, and more preferably an isocyanate group. Therefore, as a raw resin material used for the present invention, a reactive modified polyester resin (RAPE), i.e. a polyester resin modified with a group which may form a urea bonding.

A polyester prepolymer having an isocyanate group (A) may be given as an example. Examples of this prepolymer (A) is a polycondensate of a polyol (PO) and a polycarboxylic acid (PC) and a product of a reaction in which a polyester having an active hydrogen is reacted with a polyisocyanate (PIC). Examples of a group having an active hydrogen contained in the polyester include a hydroxyl group (alcoholic hydroxyl group and a phenolic hydroxyl group), an amino group, a carboxylic group and a mercapto group. Among these, an alcoholic hydroxyl group is preferable.

Regarding the modified polyester (MPE) such as urea-modified polyester, the molecular weight of the macromolecular component may be easily adjusted, and it is convenient in ensuring a dry toner, especially an oilless low-temperature fixing property (extensive releasing property and fixing property without a release oil coating mechanism to a heating medium for fixing). In particular, the polyester prepolymer whose end portion is urea-modified can suppress the adhesion to the heating medium for fixing while maintaining the high flowability and transparency in the fixing temperature region of the non-modified polyester resin itself.

Examples of the polyol (PO) include a diol (DIO) and a polyol with three or more valences (TO). It is preferably a DIO alone or a mixture of DIO with a small amount of TO.

Examples of the diol include an alkylene glycol such as ethylene glycol, 1,2-propylene glycol, 1,3-propylene glycol, 1,4-butanediol and 1,6-hexanediol; an alkylene ether glycol such as diethylene glycol, triethylene glycol, dipropylene glycol, polyethylene glycol, polypropylene glycol and polytetramethylene ether glycol); an alicyclic diol such as 1,4-cyclohexane dimethanol and hydrogenated bisphenol A; a bisphenol such as bisphenol A, bisphenol F and bisphenol S; an adduct of an alkylene oxide of the aliphatic diol such as ethylene oxide, propylene oxide and butylene oxide; and an adduct of the bisphenol of an alkylene oxide such as ethylene oxide, propylene oxide and butylenes oxide.

Among these, an alkylene glycol having a carbon number of 2 to 12 and an alkylene oxide adduct of bisphenol are preferable. The combination of an alkylene glycol having a carbon number of 2 to 12 and an alkylene oxide adduct of bisphenol is particularly preferable.

Examples of the polyol having three or more valences (TO) include a polyvalent aliphatic alcohol with three to eight valences or more such as glycerin, trimethylolethane, trimethylolpropane, pentaerythritol and sorbitol; a phenol having three or more valences such as trisphenol PA, phenol novolac and cresol novolac; and an alkylene oxide adduct of the polyphenol having three or more valences.

Examples of the polycarboxylic acid (PC) include a dicarboxylic acid (DIC) and a polycarboxylic acid with three or more valences (TC); a DIC alone and a combination of DIC and a small amount of TC are preferable. Examples of the dicarboxylic acid include an alkylene dicarboxylic acid such as succinic acid, adipic acid and sebacic acid; an alkenylene dicarboxylic acid such as maleic acid and fumaric acid; and an aromatic dicarboxylic acid such as phthalic acid, isophthalic acid, terephthalic acid and naphthalenedicaroboxylic acid. Among these, an alkenylene dicarboxylic acid having a carbon number of four to 20 and an aromatic dicarboxylic acid having a carbon number of eight to 20 are preferable. Examples of the polycarboxylic acid with three or more valences include an aromatic polycarboxylic acid having a carbon number of nine to 20 such as trimellitic acid and pyromellitic acid. Here, regarding a polycarboxylic acid, an anhydride of the above mentioned compounds or a lower alkylester such as methyl ester, ethyl ester and isopropyl ester may be used to react with the polyol. The ratio of the polyol (PO) to the polycarboxylic acid (PC) is, as an equivalent ratio of a hydroxyl group [OH] to a carboxyl group [COOH], i.e. [OH]/[COOH], usually 2/1 to 1/1, preferably 1.5/1 to 1/1, and more preferably 1.3/1 to 1.02/1.

Examples of the polyisocyanate (PIC) include an aliphatic polyisocyanate such as tetramethylenediisocyanate, hexamethylenediisocyanate, and 2,6-diisocyanatomethylcaproate; an aromatic diisocyanate such as tolylene diisocyanate and diphenylmethane diisocyanate; an aromatic-aliphatic diisocyanate such as α,α,α′,α′-tetramethylxylene diisocyanate; an isocyanurate; the polyisocyanate blocked by phenol derivative, oxime and caprolactam; and a combination of two or more of the above components.

The ratio of the polyisocyanate (PIC) is, as an equivalent ratio of an isocyanate [NCO] to a hydroxyl group [OH] of the polyester having a hydroxyl group, i.e. [NCO]/[OH], usually 5/1 to 1/1, preferably 4/1 to 1.2/1, and more preferably 2.5/1 to 1.5/1. When the ratio of [NCO]/[OH] exceeds five, the low-temperature fixing property decreases. When the molar ratio of [NCO] is less than one, in case of urea-modified polyester, the urea content of the polyester decreases, and the hot offset resistance degrades. The content of the polyisocyanate (PIC) constituent of in the polyester prepolymer having an isocyanate group at its end (A) is usually 0.5% by mass to 40% by mass, preferably 1% by mass to 30% by mass, and more preferably 2% by mass to 20% by mass. The content of less than 0.5% by mass degrades the hot offset resistance, and it is disadvantageous in terms of the compatibility between the heat-resistant storage stability and the low-temperature fixing property as well. When it exceeds 40% by mass, the low-temperature fixing property degrades. The number of isocyanate group included in one molecule of polyester prepolymer having an isocyanate group (A) is usually one or more, preferably 1.5 to three on average, and more preferably 1.8 to 2.5 on average. When it is less than one per molecule, the molecular weight of the modified polyester reduces, and the hot offset resistance degrades.

In the present invention, a urea-modified polyester used preferably as a toner binder (binding resin) component may be obtained from a reaction of the polyester prepolymer having an isocyanate group (A) and an amine (B), and the product is provided for the cross-linking and/or elongation reaction in an aqueous medium in the course of a toner manufacturing process. Examples of the amine (B) include a diamine (B1), a polyamine with three or more valences (B2), an amino alcohol (33), an amino mercaptan (B4), an amino acid (35) and a component in which an amino group of B1 to B5 is blocked (36). Examples of the diamine (B1) include an aromatic diamine such as phenylene diamine, diethyltoluene diamine, and 4,4′-diaminodiphenylmethane; an alicyclic diamine such as 4,4′-diamino-3,3′- dimethyldicyclohexylmethane, diamine cyclohexane and isophorone diamine; and an aliphatic diamine such as ethylene diamine, tetramethylene diamine and hexamethylene diamine.

Examples of the polyamine with three or more valences (B2) include diethylenetriamine and triethylenetetramine. Examples of the amino alcohol (B3) include ethanolamine and hydroxyethylaniline. Examples of the amino mercaptan (B4) include an aminomethyl mercaptan and aminopropyl mercaptan. Examples of the amino acid (B5) include aminopropionic acid and aminocaproic acid.

Examples of the component in which an amino group of B1 to B5 is blocked (B6) include a ketimine compound obtained from the amines B1 to B5 and ketones such as acetone, methyl ethyl ketone and methyl isobutyl ketone; and an oxazolidine compound. Among these amines (B), B1 and a mixture of B1 with a small amount of B2 are preferable.

Moreover, the molecular weight of the modified polyester such as urea-modified polyester may be adjusted using an elongation terminator. Examples of the elongation terminator include a monoamine such as diethylamine, dibutylamine, butylamine and laurylamine; and a ketimine that the amine functionalities of the above components are blocked. The ratio of the amines (B) is, as an equivalent ratio of an isocyanate [NCO] in the prepolymer having an isocyanate group (A) to an amino group [NHₓ] in the amine (B), i.e. [NCO]/[NHₓ], usually 1/12 to 2/1, preferably 1.5 to 1 to 1/1.5, and more preferably 1.2/1 to 1/1.2. When the ratio of [NCO]/[NHₓ] exceeds two or less than 1/2, the low-temperature fixing property decreases. When the molar ratio of [NCO] is less than one, the molecular weight of the modified polyester such as urea-modified polyester (UMPE) decreases, and the hot offset resistance degrades.

According to the present invention, the polyester modified with urea bonding (UMPE) may contain a urethane bonding as well as urea bonding. The molar ratio of the urea-bonding content to urethane-bonding content is usually 100/0 to 10/90, preferably 80/20 to 20/80, and more preferably 60/40 to 30/70. When the molar ratio of the urea bonding is less than 10%, the hot offset resistance degrades.

As a cross-linking agent and an elongation agent for the modified polyester used in the present invention, an active hydrogen compounds which can react with a reactive functional group such as isocyanate group, preferably the amines (B), may be used.

The modified polyester such as urea-modified polyester (UMPE) used as a toner binder in the present invention may be produced by means of the one-shot method or the prepolymer method. The mass-average molecular weight of the modified polyester such as urea-modified polyester is, after the modification reaction, usually 10,000 or greater, preferably 20,000 to 1,000,000, and more preferably 30,000 to 1,000,000. When it is less than 10,000, the hot offset resistance degrades. The number average molecular weight of the modified polyester such as urea-modified polyester is not restricted when a non-modified polyester (PE) hereinafter mentioned is used, and a suitable number average molecular weight may be chosen to obtain easily the mass-average molecular weight. In case of modified polyester alone, the number average molecular weight before modification is usually 20,000 or less, preferably 1,000 to 10,000, and more preferably 2,000 to 8,000. When it exceeds 20,000, the low-temperature fixing property and the gloss property for the use in a full-color apparatus degrade.

Cross-Linking Agent and Elongation Agent

In the present invention, ammes may be used as a cross-linking agent and/or an elongation agent. Examples of the amine (B) include a diamine (B1), a polyamine (B2) with three or more valences, an amino alcohol (B3), an amino mercaptan (B4), an amino acid (B5) and a component in which an amino group of B1 to B5 is blocked (B6). Examples of the diamine (B1) include an aromatic diamine such as phenylene diamine, diethyltoluene diamine, and 4,4′-diaminodiphenylmethane; an alicyclic diamine such as 4,4′-diamino-3,3′-dimethyldicyclohexylmethane, diamine cyclohexane and isophorone diamine; and an aliphatic diamine such as ethylene diamine, tetramethylene diamine and hexamethylene diamine.

Examples of the polyamine with three or more valences (B2) include diethylenetriamine and triethylenetetramine. Examples of the amino alcohol (B3) include ethanolamine and hydroxyethylaniline. Examples of the amino mercaptan (B4) include an aminomethyl mercaptan and aminopropyl mercaptan. Examples of the amino acid (B5) include aminopropionic acid and aminocaproic acid. Examples of the component in which an amino group of B1 to B5 is blocked (36) include a ketimine compound obtained from the amines B1 to B5 and ketones such as acetone, methyl ethyl ketone and methyl isobutyl ketone; and an oxazolidine compound. Among these amines (B), B1 and a mixture of B1 with a small amount of B2 are preferable.

Furthermore, a terminator may be optionally used for cross-linking and/or elongation to adjust the molecular weight of the modified polyester after the completion of reaction. Examples of the terminator include monoamine such as diethylamine, dibutylamine, butylamine and laurylamine; and a ketone compound that the amine functionalities of the above components are blocked.

The ratio of the amines (B) is, as an equivalent ratio of an isocyanate [NCO] in the prepolymer having an isocyanate group (A) to an amino group [NHₓ] in the amine (B), i.e. [NCO]/[NHₓ], usually 1/2 to 2/1, preferably 1.5 to 1 to 1/1.5, and more preferably 1.2/1 to 1/1.2. When the ratio of [NCO]/[NHₓ] exceeds two or less than 1/2, the molecular weight of the modified polyester such as urea-modified polyester decreases, and the hot offset resistance degrades.

Non-Modified Polyester

In the present invention, it is particularly preferable that the modified polyester (A) is used not only alone but also in combination with a non-modified polyester (C) with an acid value of 0.5 mg KOH/g to 40 mg KOH/g as a toner binder component. By combining (C), the low-temperature property and the gloss property in a full-color apparatus improve. Examples of the (C) include a polycondensate of a polyol (1) similar to the polyester component of the (A) with a polycarboxylic acid (2). Preferable examples thereof are equivalent to those given for (A). Also, (C) is not only the non-modified polyester but also a component modified with a chemical bonding other than urea bonding, for example, urethane bonding.

Preferably, (A) and (C) are at least partially mutually soluble in view of the low-temperature fixing property and hot offset resistance. Therefore, the polyester component of (A) preferably has a similar composition to (C). The mass ratio of (A) to (C) in case of including (A) is usually 5/95 to 75/25, preferably 10/90 to 25/75, more preferably 12/88 to 25/75, and most preferably 12/88 to 22/78. When the mass ratio of (A) is less than 5%, the hot offset resistance degrades, and it is disadvantageous in terms of the compatibility between the heat-resistant storage stability and the low-temperature fixing property as well.

The molecular-weight distribution of the non-modified polyester (C) is measured by the following method. Having precisely weighing about 1 g of non-modified polyester in an Erlenmeyer flask, 10 g to 20 g of tetrahydrofuran (THF) is added to make a THF solution having a binder concentration of 5% to 10%. A column is stabilized in a heat chamber at a temperature of 40° C. In the column at this temperature, ThF as a solvent medium is flown at a flow rate of 1 mL/min, and 20 μL of the THF sample solution is injected.

The molecular weight of the sample is calculated from the relation between the logarithmic value of a calibration curve created with a monodisperse polystyrene standard sample and the retention time. The calibration curve is created with a polystyrene standard sample. As the monodisperse polystyrene standard sample, for example, a sample having a molecular weight ranging from 2.7×10² to 6.2×10⁶ manufactured by Tosoh Corporation. As a detector, a refractive index (RI) detector is used. As a column, for example, TSKgel, G1000H, G2000H, G2500H, G3000H, G4000H, G5000H, G6000H, G7000H and GMH manufactured by Tosoh Corporation are used in combination.

The main peak molecular weight is usually 1,000 to 30,000, preferably 1,500 to 10,000, and more preferably 2,000 to 8,000. When the quantity having a molecular weight of less than 1,000 increases, the heat-resistant storage stability tends to degrade, and the carrier contamination occurs. Therefore, the quantity having a molecular weight of less than 1,000 is preferably 5.0% by mass or less. When the quantity having a molecular weight of 30,000 or greater increases, the low-temperature fixing property simply tends to decrease. However, the decrease may be suppressed by means of balance control. The content of the component having a molecular weight of 30,000 or greater is 1% or greater, and it is preferably 3% to 6% depending on the toner material. When it is less than 1%, the sufficient hot offset resistance may not be achieved. When it is 10% or greater, the gloss property and transparency may occasionally degrade.

The number average molecular weight (Mn) is 2,000 to 15,000, and the value of Mw/Mn is preferably five or less. When it is five or greater, the component lacks the sharp melting property, and the gloss property is sacrificed. Also, a polyester resin having 1% to 15% of insoluble THF may be used to improve the hot offset property. The insoluble THF in a color toner is effective for the hot offset property but is certainly a drawback for the gloss property and the OHP transparency. There are cases, however, where the composition ranging within 1% to 15% widens the releasing property.

The hydroxyl value of (C) is preferably 5 mg KOH/g or greater, more preferably 10 to 120, and most preferably 20 to 80. When it is less than five, it is disadvantageous in terms of the compatibility between the heat-resistant storage stability and the low-temperature fixing property.

The acid value of (C) is usually 0 mg KOH/g to 30 mg KOH/g, and preferably 5 mg KOH/g to 25 mg KOH/g. Given the acid value, (C) is more prone to being negatively charged. Also, (C) with the acid value and the hydroxyl value beyond their respective ranges is prone to the environmental effects under the high-temperature and high-humidity conditions as well as under the low-temperature and low-humidity conditions, resulting in the degradation of the image quality.

Here, the acid value (AV) and the hydroxyl value (OHV) can be determined specifically by the following procedure.

Measuring apparatus: Potentiometric Automatic Titrator DL53, available from Mettler-Toledo K. K.

Electrode: DG113-SC, available from Mettler-Toledo K. K.

Analysis software: LabX Light Version 1.00.000

Configuration of apparatus: A mixed solution of 120 mL of toluene and 30 mL of ethanol is used.

Measuring temperature: 23° C.

Measuring conditions are as follows:

<Stirrer>

Speed: 25%

Time: 15 seconds

<EQP Titration>

Titrant/Sensor
Titrant: CH₃ONa
Concentration: 0.1 mol/L
Sensor: DG115
   Unit of measurement: mV

Predispensing to: volume
Volume: 1.0 mL
Wait time: 0 sec

Titrant addition: Dynamic
dE(set): 8.0 mV
dV(min): 0.03 mL
dV(max): 0.5 mL

Measure mode Equilibrium controlled
dE: 0.5 mV
dt: 1.0 sec
t(min): 2.0 sec
t(max): 20.0 sec

Recognition
Threshold: 100.0

Steepest jump only: No
Range: No
Tendency: None

Termination
At maximum volume: 10.0 mL
At potential: No
At slope: No
After number EQPs: Yes
n=1
comb. Termination conditions: No

Evaluation
Procedure: Standard
Potential 1: No
Potential 2: No
Stop for reevaluation: No
   Method for Measuring Acid Value

The acid value is measured based on the measuring method described in JIS K0070-1992 with the following conditions.

Sample preparation: 0.5 g of a toner (0.3 g for ethyl acetate-soluble component) is added to 120 mL of toluene, and the mixture is agitated at a room temperature (23° C.) for 10 hours for dissolution. Furthermore, 30 mL of ethanol is added, and a sample solution is prepared.

The acid value may be calculated with the above-mentioned apparatus; the specific calculation procedure is as follows.

The sample is titrated with a pre-evaluated 10/N alcoholic solution of caustic potassium, and the acid value is obtained from the consumption rate of the alcoholic potassium solution and the formula below:
Acid value=KOH (in mL)×N×56.1/mass of the sample
where N is the factor in N/10 KOH.
Method for Measuring Hydroxyl Value

In a 100-mL volumetric flask, 0.5 g of a sample is precisely weighed, to which 5 mL of acetylating sample is properly added. Then, the flask is immersed and heated in a bath at a temperature of 100±5° C. After one to two hours, the flask is removed from the bath, stood to cool, and shook with an addition of water to decompose acetic anhydride. Then, the flask is again heated in a bath for 10 minutes or more and stood to cool, and the wall of the flask is rinsed well with an organic solvent. This solution is potentiometrically titrated with an N/2 ethyl alcohol solution of potassium hydroxide using the electrode to find the hydroxyl value. This method is based on JIS K0070-1966.

The amount of the insoluble THF in the toner may be adjusted by controlling the elongation and/or cross-linking of the modified polyester by means of the acid value of the non-modified polyester.

The measurement methods are shown below.

<Method for Measuring Insoluble THF>

About 1.0 g of a resin or a toner (A) is weighed. To this, about 50 g of THF is added, and the mixture is left to stand at a temperature of 20° C. over 24 hours. This is first centrifuged and filtered with qualitative filter paper of Class SC specified by the Japan Industrial Standards (JIS P3801). The solvent portion of the filtrate is dried in a vacuum, and the residual amount (B) is measured only for the resin. The residual amount is the amount of the soluble THF.

The amount of the insoluble THF (%) is found by the following equation:
Insoluble THF (%)=(A−B)/A

In case of toner, the component amount of the insoluble THF (W1) and the component amount of the soluble THF (W2) other than resin are checked separately by a heretofore known method such as thermal reduction method with the TG technique (transient grating technique), and the amount of insoluble THF may be found from the following equation:
Amount of insoluble THF (%)=(A−B−W2)/(A−W1−W2)×100

In the present invention, a modified polyester and a non-modified polyester are included as resin components in a toner. Since a polymer which includes an elongated and/or cross-linked modified polyester has a high molecular weight, a distinct glass transition behavior is not observed. Therefore, there is no difference between the glass transition temperature (Tg) of the toner and the glass transition temperature (Tg) of the non-modified polyester, and the glass transition temperature (Tg) of the toner may be adjusted with the glass transition temperature (Tg) of the non-modified polyester. The glass transition temperature of the toner is usually 40° C. to 70° C., and preferably 45° C. to 55° C. When it is less than 40° C., the heat-resistant storage stability of the toner degrades. When it exceeds 70° C., the low-temperature fixing property is insufficient. Due to the coexistence of a cross-linked and/or elongated polyester resin, a dry toner of the present invention shows a tendency of having the favorable heat-resistant storage property even with a low glass transition temperature compared to a heretofore known polyester toner.

<Method for Measuring Glass Transition Temperature (Tg)>The glass transition temperature (Tg) is determined specifically with the following procedure. The glass transition temperature is measured with measuring apparatuses, TA-60WS and DSC-60 manufactured by Shimadzu Corporation, and the following conditions.

(Measuring Conditions)

Sample container: Aluminum sample pan with a lid

Sample quantity: 5 mg

Reference: Aluminum sample pan with 10 mg of alumina

Atmosphere: Nitrogen with a flow rate of 50 mL/min

Temperature conditions
Starting temperature: 20° C.
Rate of temperature increase: 10° C./min
Target temperature: 150° C.
Retention time: none
Rate of temperature decrease: 10° C./min
Target temperature: 20° C.
Retention time: none
Rate of temperature increase: 10° C./min
Final temperature: 150° C.

The results of the measurement may be analyzed with the data analysis software (TA-60, version 1.52) manufactured by Shimadzu Corporation. Regarding the method of analysis, a range of ±5° C. from the temperature showing the maximum peak to the low-temperature side of a DrDSC curve as a DSC differential curve of the second temperature increase is specified, and the peak temperature is determined with the peak analysis function of the analysis software. Next, in the range of +5° C. and −5° C. from the peak temperature of the DSC curve, the maximum heat absorption temperature is determined. The temperature indicated here corresponds to the glass transition temperature (Tg) of the toner.

Colorant

As a colorant of the present invention, a heretofore know dye may be used, and a pigment may be preferably used. Preferable examples include: carbon black, nigrosine dye, iron black, naphthol yellow S, Hanza Yellow (10G, 5G, G), cadmium yellow, yellow iron oxide, ocher, chrome yellow, titanium yellow, polyazo yellow, oil yellow, Hanza Yellow (GR, A, RN, R), Pigment Yellow L, benzidine yellow (G, GR), Permanent Yellow (NCG), Balkan Fast Yellow (5G, R), Tartrazine lake, quinoline yellow lake, anthrazine yellow BGL, isoindolinone yellow, iron oxide red, minium, crocosite, cadmium red, cadmium mercury red, antimony vermilion, permanent red 4R, Para Red, Phiser Red, parachloro-o-nitroaniline red, Resol Fast Scarlet G, Brilliant Fast Scarlet, Brilliant Carmine BS, permanent red (F2R, F4R, FRL, FRLL, F4RH), Fast Scarlet VD, Balkan Fast Rubin B, Brilliant Scarlet G, Resol Rubin GX, Permanent Red F5R, Brilliant Carmine 6B, Pigment Scarlet 3B, Bordeaux 5B, Toluidine Maroon, Permanent Bordeaux F2K, Hellio Bordeaux BL, Bordeaux 10B, Bon Maroon Light, Bon Maroon Medium, eosine lake, Rhodamine Lake B, Rhodamine Lake Y, Aliline Lake, thioindigo red B, thioindigo maroon, oil red, quinacridone red, pyrazolne red, polyazo red, chromium vermilion, benzidine orange, perinone orange, perinone orange, oil orange, cobalt blue, cerulean blue, alkali blue lake, peacock blue lake, Victoria blue lake, nonmetallic phthalocyanine blue, phthalocyanine blue, fast sky blue, Indanthrene Blue (RS, BC), indigo, ultramarine, Prussian blue, anthraquinone blue, Fast Violet B, Methyl Violet Lake, cobalt purple, manganese purple, dioxane violet, anthraquinone violet, chromium green, zinc green, chromium oxide, pyridian, emerald green, Pigment Green B, Naphthol Green B, green gold, acid green lake, malachite green lake, phthalocyanine green, anthraquinone green, titanium oxide, zinc white and lithopone. These may be used alone or in combination. Among these, preferable colorants are: C. I. Pigment Yellow 74, C. I. Pigment Yellow 83, C. I. Pigment Yellow 93, C. I. Pigment Yellow 97, C. I. Pigment Yellow 110, C. I. Pigment Yellow 120, C. I. Pigment Yellow 128, C. I. Pigment Yellow 138, C. I. Pigment Yellowl39, C. I. Pigment Yellow 151, C. I. Pigment Yellow 153, C. I. Pigment Yellow 155, C. I. Pigment Yellow 174, C. I. Pigment Yellow 180, C. I. Pigment Yellow 183, C. I. Pigment Yellow 185, C. I. Pigment Yellow 213, C. I. Pigment Yellow 214, C. I. Pigment Red 48:2, C. I. Pigment Red 48:3, C. I. Pigment Red 48:4, C. I. Pigment Red 53:1, C. I. Pigment Red 53:3, C. I. Pigment Red 57:1, C. I. Pigment Red 122, C. I. Pigment Red 144, C. I. Pigment Red 146, C. I. Pigment Red 166, C. I. Pigment Red 176, C. I. Pigment Red 184, C. I. Pigment Red 185, C. I. Pigment Red 238, C. I. Pigment Red 254, C. I. Pigment Red 269, C. I. Pigment Blue 15:3 and C. I. Pigment Blue 15:4. The following colorants are particularly effective: C. I. Pigment Yellow 74, C. I. Pigment Yellow 93, C. I. Pigment Yellow 128, C. I. Pigment Yellow 155, C. I. Pigment Yellow 180, C. I. Pigment Yellow 185, C. I. Pigment Red 57:1, C. I. Pigment Red 122, C. I. Pigment Red 146, C. I. Pigment Red 184, C. I. Pigment Red 185, C. I. Pigment Red 238, C. I. Pigment Red 269 and C. I. Pigment Blue 15:3.

The composition of the colorant with respect to the toner is preferably 1% by mass to 15% by mass, and more preferably 3% by mass to 10% by mass.

A rosin treatment is an example of the acid treatment of the colorant used in the present invention. The rosin treatment is a method in which an alkaline solution of rosin followed by a metal salt of a lake such as calcium chloride is introduced to a coupler solution including 2-hydroxy-3-naphthoic acid or a dye having 2-amino-5-methyl-benzenesulfonic acid coupled with 2-hydroxy-3-naphthoic acid to deposit a rosin on the surface of the pigment produced from the dye as a metal salt of a rosin lake.

Also, sulfonation is an example of the pigment surface treatment method. A sulfonation reaction performed as an ordinary organic reaction may be used when a solvent which does not react with sulfonation agent and is insoluble or hardly soluble is selected as the dispersion solvent of the reaction system. Examples of the sulfonation agent include sulfuric acid, fuming sulfuric acid, sulfir trioxide, chlorosulfc acid, fluorosulfuric acid and amidosulfuric acid. In other cases where sulfur trioxide is inappropriate for its too strong reactivity or the presence of a strong acid is not preferable, a sulfonation may be performed using a complex of sulfur trioxide with a tertiary amine. Furthermore, in some cases, a Lewis acid such as aluminum chloride and tin chloride may be used as a catalyst. Here, the types of solvent in a reaction, the reaction temperature, the reaction time and the types of the sulfonation agent vary depending on the types of the pigment and the reaction system.

The amount of these treatment agents added in the pigment surface treatment with respect to the colorant is preferably 0.1% by mass to 100% by mass, and more preferably 0.1% by mass to 10% by mass.

The colorant used in the present invention may be used as a master batch in a composite with a resin as well. Examples of the binding resin which is used in the production of the master batch or kneaded with the master batch include, other than the modified and non-modified polyester resins, a styrene and a polymer of the substitution product thereof such as polystyrene, poly-p-chlorostyrene and polyvinyltoluene; a styrene copolymer such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-a-chloromethyl methacrylate copolymer, styrene-acrylonitrile copolymer, styrene-vinyl methyl ketone copolymer, styrene-butadiene copolymer, styrene-isoprene copolymer, styrene-acrylnitrile-indene copolymer, styrene-maleic acid copolymer and styrene-maleate copolymer; polymethylmethacrylate, polybutylmethacrylate, polyvinyl chloride, polyvinyl acetate, polyethylene, polypropylene, polyester, epoxy resins, epoxy polyol resins, polyurethanes, polyamides, polyvinyl butyral, polyacrylic resins, rosin, modified rosin, terpene resin, aliphatic or alicyclic hydrocarbon resins, aromatic petroleum resins, chlorinated paraffin and paraffin wax. These may be used alone or in combination.

The master batch may be obtained by mixing and kneading the resin for a master batch and the colorant with an application of high shearing force. To enhance the interaction between the colorant and the resin, an organic solvent may be used. Also, the so-called flashing method may be preferably used in which an aqueous paste including the colorant and water is mixed and kneaded with the resin and the organic solvent to transfer the colorant to the resin for removing the moisture and the organic solvent components since the wet cake of the colorant is used as it is and drying is unnecessary. A high shearing force dispersing apparatus such as three-roll mill is preferably used for mixing and kneading.

Dispersant

In the present invention, the colorant is dispersed by a dispersant having an acid value of 1 mg KOH/g to 30 mg KOH/g and an amine value of 1 mg KOH/g to 100 mg KOH/g. More preferably, the dispersant has an acid value of 1 mg KOH/g to 20 mg KOH/g and an amine value of 10 mg KOH/g to 50 mg KOH/g. When the acid value exceeds 30 mg KOH/g, the charge property under high humidity decreases, and the pigment dispersibility is insufficient. Also, when the amine value is less than 1 mg KOH/g or greater than 100 mg KOH/g, the pigment dispersibility is also insufficient. Here, the acid value may be measured according to the method specified by JIS K7237. Also, the dispersant is preferably highly soluble with the binding resin in terms of the pigment dispersibility.

Specific examples of the dispersant which filfills these required conditions are: AJISPER PB-711, AJISPER PB-821, AJISPER PB-822 and AJISPER PB-824 manufactured by Ajinomoto Fine-Techno Co., Inc.; Disperbyk-112, Disperbyk-116, Disperbyk-161, Disperbyk-162, Disperbyk-163, Disperbyk-164, Disperbyk-166, Disperbyk-167, Disperbyk-168, Disperbyk-2000, Disperbyk-2001, Disperbyk-2050, Disperbyk-2070, Disperbyk-2150 and Disperbyk-9077 manufactured by BYK-Chemie GmbH; EFKA-4008, EFKA-4009, EFKA-4010, EFKA-4046, EFKA-4047, EFKA-4520, EFKA-4015, EFKA-4020, EFKA-4050, EFKA-4055, EFKA-4060, EFKA-4080, EFKA-4300, EFKA-4330, EFKA-4400, EFKA-4401, EFKA-4402, EFKA-4403, EFKA-4406 and EFKA-4510 manufactured by EFKA Chemicals BV. Among these, AJISPER PB-821 and AJISPER PB-822 manufactured by Ajinomoto Fine-Techno Co., Inc., Disperbyk-2001 manufactured by BYK-Chemie GmbH and EFKA-4010 manufactured by EFKA Chemicals BV are suitable.

The dispersant is preferably formulated at a proportion of 0.1% by mass to 10% by mass with respect to the colorant in the toner. When the composition is less than 0.1% by mass, the pigment dispersibility is insufficient. When the composition is greater than 10% by mass, the charge property under high humidity may be reduced. The mass average molecular weight of the dispersant is, in terms of the molecular weight of a main peak local maximum value in the styrene conversion mass according to Gel Permeation Chromatography, preferably 2,000 or greater, and more preferably 3,000 or greater for the pigment dispersibility. In particular, it is preferably 5,000 to 50,000, and more preferably 5,000 to 30,000. When the molecular weight is less than 500, the polarity increases, and the dispersibility of the colorant tends to decrease. When the molecular weight exceeds 100,000, the affinity of the solvent increases, and the dispersibility of the colorant tends to decrease.

The amount of the dispersant added is, with respect to 100 parts of the colorant, preferably one part by mass to 50 parts by mass, and more preferably five parts by mass to 30 parts by mass. When it is less than one part by mass, the dispersion power decreases. When it is greater than 50 parts by mass, the charge property tends to decrease. These dispersants may be used alone or in combination with other dispersants. Examples of the other dispersants include a polyester dispersant, an acrylic acid, a polymer of methacrylic acid and/or its ester and a colorant derivative.

In the present invention, by using a pigment dispersant with acid treatment on the pigment surface, the amine site of the dispersant is adsorbed to the acidic pigment surface. Therefore, the abundance of the dispersant polymer having an amine value prone to the positive charge property disappears on the toner surface, and the abundance of the acidic site of the dispersant increases on the toner surface. As a result, the negative charge property is not inhibited for the toner with the negative charge property.

The formulation ratio of the colorant to the organic solvent in the colorant dispersion is preferably in the range of 5/95 to 50/50. When the formulation ratio of the colorant is below this range, the quantity of the dispersion increases in the preparation of a toner, and the efficiency of the toner preparation tends to decrease. When the formulation ratio of the colorant is above this range, the dispersion of the pigment tends to be insufficient.

The colorant may be used as a colorant dispersion obtained by dispersing in advance only the colorant in the organic solvent, or the colorant may be dispersed directly in the organic solvent along with the binding resin, the dispersant and the dispersing resin. Also, in the case where the colorant is dispersed beforehand, the binding resin may be partially introduced to adjust the viscosity in order to add the appropriate shearing force in pigment dispersion.

The particle diameter of the colorant in the dispersion after the colorant dispersion is preferably 1 μm or less. When it is greater than 1 μm, the particle size of the colorant enlarges in the formation of the toner, and the image quality, in particular the OHP optical transparency tends to decrease. Here, the particle diameter of the colorant can be found with a laser-Doppler dispersion measuring apparatus, UPA-150, manufactured by Nikkiso Co., Ltd.

In the present invention, a colorant derivative with high affinity with the colorant may be introduced in order to enhance the interaction between the colorant and the dispersant as well as stabilize the dispersibility of the colorant. Specific examples of the colorant derivative include: dimethylaminoethylquinacridone, dihydroquinacridone, a carboxylic acid derivative of anthraquinone and a sulfonic acid derivative of anthraquinone; SOLSPERSE 5000, SOLSPERSE 12000 and SOLSPERSE 22000 manufactured by Avecia Ltd.; and EFKA-6745, EFKA-6746 and EFKA-6750 manufactured by EFKA Chemicals BV. The amount of the colorant derivative added with respect to the colorant is preferably 0.1% by mass to 100% by mass, and more preferably 0.1% by mass to 10% by mass.

In the present invention, the amino group in the colorant dispersant is adsorbed to the surface of the colorant surface which has been given an acid treatment. Therefore, the abundance of the amino group of the dispersant on the toner surface decreases, and the abundance of the acid group of the dispersant on the toner surface increases. Because of this, the favorable negative charge property may be obtained. Also, even when the acid value of the colorant dispersant is 0 mg KOH/g, the amino group of the colorant dispersant efficiently adsorbs on the colorant surface. Therefore, the decrease of the negative charge property may be suppressed. In addition, by the addition of a copolymer having an acid group, the negative charge property of the toner may be controlled.

In the present invention, a colorant derivative having high affinity with the colorant may be introduced in order to enhance the interaction between the colorant and the colorant dispersant as well as stabilize the dispersibility of the colorant. Specific examples of the colorant derivative include: dimethylaminoethylquinacridone, dihydroquinacridone, a carboxylic acid derivative of anthraquinone and a sulfonic acid derivative of anthraquinone;

SOLSPERSE 5000, SOLSPERSE 12000 and SOLSPERSE 22000 manufactured by Avecia Ltd.; and EFKA-6745, EFKA-6746 and EFKA-6750 manufactured by EFKA Chemicals BV. The amount of the colorant derivative added with respect to the colorant is preferably 0.1% by mass to 100% by mass, and more preferably 0.1% by mass to 10% by mass.

Releasing Agent

Also, the toner may include a wax as a releasing agent along with the binding resin and the colorant. Regarding the wax, a heretofore known wax may be used, and examples thereof include a polyolefin was such as polyethylene wax and polypropylene wax; a long-chain hydrocarbon such as paraffin wax and Sasol Wax; and a wax having a carbonyl group. Among these, the wax having a carbonyl group is preferable.

Examples of the wax having a carbonyl group include polyalkanoic acid such as carnauba wax, montan wax, trimethylolpropane tribehenate, pentaerythritol tetrabehenate, pentaerythritol diacetate dibehenate, glycerine tribehenate and 1,18-octadecanediol distearate; a polyalkanol ester such as trimellitic acid tristearyl and distearyl maleate; a polyalkanoic acid amide such as ethylenediamine dibehenyl amide; a polyalkylamide such as trimellitic acid tristearyl amide; and a dialkyl ketone such as distearyl ketone. Among these waxes having a carbonyl group, polyalkanoic acid ester is preferable.

The melting point of the wax of the present invention is usually 40° C. to 160° C., preferably 50° C. to 120° C., and more preferably 60° C. to 90° C. A wax with a melting point of less than 40° C. adversely affects the heat-resistant preservation stability, and a wax with a melting point exceeding 160° C. tends to cause a cold offset in fixing at a low temperature. Also, the melt viscosity of the wax is, as a value measured at a temperature higher than its melting point by 20° C., preferably 5 cps to 1,000 cps, and more preferably 10 cps to 100 cps. A wax with a melt viscosity exceeding 1,000 cps has insufficient effects in enhancing the hot offset resistance and the low-temperature fixing property. The content of the wax in a toner is usually 0% by mass to 40% by mass, and preferably 3% by mass to 30% by mass.

The melting point of the releasing agent may be determined by a DSC curve obtained with a differential scanning calorimetry measurement (DSC). Here, the DSC curve may be obtained by measuring with TA-60WS and DSC-60, manufactured by Shimadzu Corporation and the following measuring conditions.

Sample container: Aluminum sample pan with a lid

Sample quantity: 5 mg

Reference: Aluminum sample pan with 10 mg of alumina

Atmosphere: Nitrogen with a flow rate of 50 mL/min

Temperature conditions
Starting temperature: 20° C.
Rate of temperature increase: 10° C./min
Target temperature: 150° C.
Retention time: none
Rate of temperature decrease: 10° C./min
Target temperature: 20° C.
Retention time: none
Rate of temperature increase: 10° C./min
Final temperature: 150° C.

The results of the measurement may be analyzed with the data analysis software (TA-60, version 1.52) manufactured by Shimadzu Corporation. Regarding the method of analysis, a range of ±5° C. from the temperature showing the maximum peak to the low-temperature side of a DrDSC curve as a DSC differential curve of the second temperature increase is specified, and the peak temperature is determined with the peak analysis function of the analysis software. Next, in the range of +5° C. and −5° C. from the peak temperature of the DSC curve, the maximum heat absorption temperature is determined. This temperature corresponds to the melting point of the releasing agent.

Charge Controller

The toner of the present invention may include a charge controller according to requirements. A heretofore known charge controller may be used, and examples of the charge controller include a nigrosine dye, a triphenylmethane dye, a metal complex dye containing chromium, a molybdic acid chelate pigment, a Rhodamine dye, alkoxy amine, quaternary ammonium salt including fluorine-modified quaternary ammonium salt, alkylamide, phosphorus as an element or a compound, tungsten as an element or a compound, fluorine activator, metal salt of a salicylic acid and metal salt of salicylic acid derivative.

Specific examples thereof include BONTRON 03 (nigrosine dye), BONTRON P-51 (quaternary ammonium salt), BONTRON S-34 (metallized azo dye), E-82 (metal complex of oxynaphthoic acid), E-84 (metal salt of salicylic acid) and E-89 (phenolic condensate), manufactured by Orient Chemical Industries, Ltd.; TP-302 and TP-415 (molybdenum complex of quaternary ammonium salt) manufactured by Hodogaya Chemical Co., LTD.; COPY CHARGE PSY VP2038 (quaternary ammonium salt), COPY BLUE (triphenyl methane derivative), COPY CHARGE NEG VP2036 and NX VP434 (quaternary ammonium salt), manufactured by Hoechst AG; LRA-901 and LR-147 (boron complex), manufactured by Japan Carlit Co., Ltd.; copper phthalocyanine, perylene, quinacridone, azo pigments and polymers having a functional group such as sulfonate group, carboxyl group and quaternary ammonium group.

The amount of the charge controller used in the present invention varies depending on the manufacturing method including the type of the binding resin, the presence or absence of the optionally used additives and the dispersion method, and it may not be unambiguously determined. It is, however, preferably 0.1 parts by mass to 10 parts by mass per 100 parts by mass of the binding resin. The amount of the charge controller exceeding 10 parts by mass increases the charge property too much and weakens the effect of the main charge controller. The electrostatic attraction with a developing roller increases, causing the decrease in the flowability of the developer and the image quality. These charge controllers may be dissolved and dispersed after being melted and kneaded with the master batch and the resin; it may of course be added directly to the organic solvent in dissolution and dispersion; or it may be fixed on the toner surface after preparing the toner particles.

Resin Particles

The resin particles used in the present invention are for controlling the toner shape such as degree of circularity and particle size distribution and are introduced in the manufacturing process. The resin particles are required to have a glass transition temperature (Tg) of 30° C. to 70° C. as well as a mass average molecular weight of 8,000 to 400,000. Resin particles having a glass transition temperature (Tg) of less than 30° C. and/or a mass average molecular weight of less than 8,000 degrade the storage stability of the toner and causes a blocking during storage and in a developing unit. Resin particles having a glass transition temperature (Tg) exceeding 70° C. and/or a mass average molecular weight exceeding 400,000 inhibit the adhesion with fixing paper and hence increase the lower limit of the fixing temperature.

It is extremely preferable to maintain the residual rate against the toner particles within 0.5% by mass to 5.0% by mass. The residual rate of less than 0.5% by mass reduces the storage stability of the toner and causes a blocking during storage and in a developing unit. When the residual rate exceeds 5.0% by mass, the resin particles inhibit the exudation of the wax. Therefore, the effect of the releasing property of the wax cannot be achieved, and an occurrence of an offset is observed.

The residual rate of the resin particles can be measured by analyzing the material coming from not the toner particles but the resin particles with a pyrolysis gas chromatograph mass spectrometer and calculating from the peak area. The detector is preferably a mass spectrometer, but it is not particularly restricted.

Any resin may be used for the resin particles as long as it forms an aqueous dispersion, and it may be a thermoplastic resin or a thermosetting resin. Examples thereof include a vinyl resin, a polyurethane resin, an epoxy resin, a polyester resin, a polyamide resin, a polyimide resin, a silicon resin, a phenol resin, a melamine resin, a urea resin, an aniline resin, an ionomer resin and a polycarbonate resin. These resins may be used alone or in combination of two or more types of the resin particles. Among these, a vinyl resin, a polyurethane resin, an epoxy resin, a polyester resin and a combination thereof are preferable in view of easily obtaining an aqueous dispersoid of fine and spherical resin particles.

The resin particles preferably have a particle diameter of 5 nm to 500 nm. When the average particle diameter of the resin particles is less than 5 nm, the resin particles remaining on the toner surface become a film or cover thickly the whole surface of the toner. Therefore, the particles of the releasing agent inhibit the adhesion between the binding resin component inside the toner and fixing paper, the lower limit of the fixing temperature increases, and furthermore, it becomes difficult to control the diameter and the shape of the particles. When the particle diameter of the resin particles exceeds 500 nm, the resin particles remaining on the toner surface project largely upward as a salient portion. Also, the resin particles remain as a multilayer in a coarse state, and it is observed that the particles of the releasing agent desorb due to the stress of the agitation in the developing unit.

The particle diameter of the resin particles may be measured with a laser-Doppler dispersion measuring apparatus manufactured by Nikkiso Co., Ltd. as follows. A sample is diluted with ion-exchanged water, and an emulsified dispersion having a solid content of resin particles of 0.6% by mass (specified in the range of 0.5% by mass to 1.0% by mass) is prepared for the measurement. The specific measuring conditions are as follows:

Distribution displayed in: volume

Number of channels: 52

Measuring duration: 30 seconds

Particle refractive index: 1.81

Temperature: 25° C.

Particle shape: Non-spherical

Viscosity: 0.8750 cP

Solvent refractive index: 1.333

Solvent: water

The emulsified dispersion to be measured is injected with a dropping pipet or a syringe such that the sample Loading displayed on the laser-Doppler dispersion measuring apparatus is within the range of one to 100.

The vinyl resin is a polymer that a vinyl monomer is homopolymerized or copolymerized, and examples thereof include a styrene-(meth)acrylic ester resin, a styrene-butadiene copolymer, a (meth)acrylic acid-acrylic ester polymer, a styrene-acrylonitrile copolymer, a styrene-maleic anhydride copolymer and a styrene-(metb)acrylic acid copolymer.

Inorganic Particles

To supplement the heat-resistant storage stability and the charge property of the coloring particles obtained in the present invention, inorganic particles may be used in the course of the production. The primary particle diameter of the inorganic particles is preferably 0.5 nm to 200 nm, and most preferably 0.5 nm to 50 nm. Also, the specific surface according to the BET method is preferably 20 m²/g to 500 m²/g. The ratio of the inorganic particles used with respect to the toner is preferably 0.01% by mass to 5% by mass, and more preferably 0.01% by mass to 2.0% by mass.

Examples of the inorganic particles include tricalcium phosphate, colloidal silica, alumina, titanium oxide, barium titanate, magnesium titanate, calcium titanate, strontium titanate, zinc oxide, tin oxide, silica sand, clay, mica, wollastonite, diatom earth, chrome oxide, cerium oxide, colcothar, antimony trioxide, magnesium oxide, zirconum oxide, barium sulfate, barium carbonate, calcium carbonate, silicon carbide, silicon nitride and hydroxyapatite.

The toner of the present invention has a BET specific surface of 0.5 m²/g to 6.0 m²/g. The image quality tends to be affected by the presence of coarse particles and the inclusion of the additives having a BET specific surface of less than 0.5 m²/g and by the presence of fine particles, the relief of the additives and the surface asperity with a BET specific surface exceeding 6.0 m²/g.

The BET specific surface of the toner of the present invention may be obtained by measuring with an apparatus which is compliant with the JIS standards (Z 8830 and R 1626) such as NOVA series manufactured by Yuasa Ionics Co., Ltd.

External Additive

In the present invention, an external additive such as a fluidizer, a cleaning ability enhancer, a charge controller may be externally added to the toner formed using a liquid medium. Examples of the external additive that supplements the flowability and the developing property of the coloring particles obtained in the present invention include polymer particles such as polystyrene, methacrylate ester and acrylic ester copolymer obtained by soap-free emulsion polymerization, suspension polymerization and dispersion polymerization; a polycondensate such as silicone, benzoguanamine and nylon; and polymer particles of a thermosetting resin.

The fluidizer is given a surface treatment to enhance its hydrophobic property, and it can prevent the degradation of the flowability and the charge property even under high humidity. Preferable examples of the surface treatment agent include a silane coupling agent, a silylation agent, a silane coupling agent having an alkyl fluoride group, an organic titanate coupling agent, an aluminate coupling agent, a silicone oil and a modified silicone oil.

Examples of the cleaning ability enhancer that removes the developer remaining on a photoconductor and a primary transfer medium after transferring include a metal salt of a fatty acid such as zinc stearate, calcium stearate and stearic acid; and polymer particles manufactured by soap-free emulsion polymerization such as polymethylmethacrylate particles and polystyrene particles. The polymer particles preferably have a comparatively narrow particle size distribution with a volume average particle diameter of 5 0.01 μm to 1 μm.

(Method for Manufacturing Toner)

The toner binder (binding resin) may be manufactured by the following method. The polyol (1) and polycarboxylic acid (2) are heated to a temperature of 150° C. to 280° C. under the presence of a heretofore known esterification catalyst such as tetrabutoxytitanate and dibutyl tin oxide, and by distilling off the generated water under reduced pressure if necessary, a polyester having a hydroxyl group is obtained. Then, at a temperature of 40° C. to 140° C., the polyester is reacted with polyisocyanate (3) to obtain the prepolymer having an isocyanate group (A).

The dry toner of the present invention may be manufactured by the following method, but it is not of course restricted to these.

Method for Manufacturing Toner in Aqueous Medium

To the aqueous phase used in the present invention, organic particles (resin particles) are preferably added in advance. The water used for the aqueous phase may be water alone, but a solvent which is miscible with water may be used in combination. Examples of the solvent which is miscible with water include an alcohol such as methanol, isopropanol and ethylene glycol, dimethylformamide, tetrahydrofuran, a cellosolve such as methyl cellosolve and a lower ketone such as acetone and methyl ethyl ketone.

A prepolymer (A) in a dispersion that an oily dispersoid of an organic solvent including a polyester prepolymer having an isocyanate group (A) dissolved or dispersed in an organic solvent in an aqueous phase is dispersed in the form of droplets in an aqueous phase is reacted with amine (B), and the toner particles may be obtained. For example, a method for stably forming dispersoid droplets is that a composition liquid of the toner particles having polyester prepolymer (A) dissolved or dispersed in an organic solution is added to an aqueous phase, which is dispersed with the application of a shearing force. The polyester prepolymer (A) dissolved or dispersed in the organic solvent as well as other toner materials such as colorant, colorant master batch, releasing agent, charge controller and non-modified polyester resin (hereinafter referred to as the toner materials) may be mixed in forming a droplet dispersoid in an organic solvent. However, it is more preferable to mix the toner materials in advance, then dissolve or disperse them in an organic solvent and finally add the mixture to an aqueous phase for dispersion. Also, in the present invention, other toner materials such as colorant, releasing agent and charge controller do not necessarily have to be mixed in forming particles in the aqueous phase, but they may be added after the formation of the particles. For example, a colorant may be introduced by means of a heretofore known dyeing method after particles which do not include the colorant are formed.

The dispersion method is not restricted, and a heretofore known apparatus such as low-speed shearing, high-speed shearing, friction, high-pressure jet and ultrasonic apparatuses may be applied. It is preferably a high-speed shearing apparatus in order to have a particle diameter of the droplet dispersoid of 2 μm to 20 μm. For a high-speed sharing distribution apparatus, the number of revolutions is not particularly restricted, but it is usually 1,000 rpm to 30,000 rpm, and more preferably 5,000 rpm to 20,000 rpm. The dispersion time is not particularly restricted, but in a batch processing system, it is usually 0.1 minutes to five minutes. The dispersion temperature is usually 0° C. to 150° C. under pressurization, and preferably 40° C. to 98° C. The higher dispersion temperature is preferable for easier dispersion since it produces a dispersoid composed of the polyester prepolymer (A) having a low viscosity.

The amount of the aqueous phase used per 100 parts of an organic solvent (oil phase) of the toner composition materials including the polyester prepolymer (A) is usually 50 parts by mass to 20,000 parts by mass, and preferably 100 parts by mass to 10,000 parts by mass. When it is less than 50 parts by mass, the dispersion condition of the oil droplets is not satisfactory, and toner particles having a predetermined particle diameter cannot be obtained. The amount exceeding 20,000 parts by mass is not economical. Also, a dispersant may be used according to requirements. It is preferable to use a dispersant for a sharp particle distribution as well as stable dispersion.

Examples of the dispersant for emulsifying or dispersing the oil phase in which the toner composition materials are dispersed or dissolved in the aqueous phase include an anionic surfactant such as alkylbenzene sulfonate, α-olefin-sulfonate and phosphate; a cationic surfactant of amine salt type such as alkylamine salt, amino alcohol fatty acid derivative, polyamine alcohol fatty acid derivative and imidazoline; a cationic surfactant of quaternary ammomum salt type such as alkyltrimethyl ammonium salt, dialkyldimethyl ammonium salt, alkyldimethylbenzyl ammonium salt, pyridinium salt, alkylisoquinolinium salt and benzethonium chloride; a nonionic surfactant such as fatty amide derivative and polyol derivative; and an amphoteric surfactant such as alanine, dodecyldi(aminoethyl)glycine, di(octylaminoethyl)glycine and N-alkyl-N,N-dimethyl ammonium betaine.

In addition, the use of a surfactant having a fluoroalkyl group may largely enhance the effect even in a small amount. Examples of the preferably used anionic surfactant having a fluoroalkyl group includes fluoroalkylcarboxylate having a carbon number of two to 10 and its metal salt, perfluoro octanesulfonyl disodium glutamate, 3-[omega-fluoroalkyloxy (C₆ to C₁₁)]-1-alkyl (C₃ to C₄) sodium sulfonate, 3-[omega-fluoroalkoyl (C₆ to C₈)-N-ethylamino]-1-propane sodium sulfonate, fluoroalkyl (C₁₁ to C₂₀) carboxylic acid and its metal salt, perfluoroalkyl carboxylic acid (C₇ to C₁₃) and its metal salt, perfluoroalkyl (C₄ to C₁₂) sulfonic acid and its metal salt, perfluorooctane sulfonic acid diethanolamide, N-propyl-N-(2-hydroxyethyl)perfluorooctane sulfonamide, perfluoroalkyl (C₆ to C₁₀) sulfonamidepropyltrimethyl ammomum salt, periluoroalkyl (C₆ to C₁₀-N-ethylsulfonylglycin salt and monoperfluoroalkyl (C₆ to C₁₆) ethylphosphate.

Examples thereof as commercial names include: SURFLON S-111, S-112 and S-113 manufactured by Asahi Glass Co., Ltd.; Fluorad FC-93, FC-95, FC-98 and FC-129 manufactured by Sumitomo 3M Limited; Unidyne DS-101 and DS-102 manufactured by Daikin Industries, Ltd.; MEGAFACE F-110, F120, F113, F191, F812 and F833 manufactured by DAINIPPON INK AND CHEMICALS, INCORPORATED; EFTOP EF-102, 103, 104, 105, 112, 123A, 123B, 306A, 501, 201 and 204 manufactured by Tohkem Products Co., Ltd.; and FTERGENT F-100 and F150 manufactured by NEOS Co., Ltd.

Also, examples of the cationic surfactant include an aliphatic primary and secondary acids or secondary amine acid; an aliphatic quaternary ammonium salt such as perfluoroalkyl (C₆ to C₁₀) sulfonamide propyltrimethyl ammonium salt; benzalkonium salt; benzethonium chloride; a pyridinium salt; and an imidazolinium salt. Examples of commercially available cationic surfactants include SURFLON S-121 manufactured by Asahi Glass Co., Ltd.; Fluorad FC-135 manufactured by Sumitomo 3M Limited; Unidyne DS-202 manufactured by Daikin Industries, Ltd.; MEGAFACE F-150 and F-824 manufactured by DAINIPPON INK AND CHEMICALS, INCORPORATED; EFTOP EF-132 manufactured by Tohkem Products Co., Ltd.; and FTERGENT F-300 manufactured by NEOS Co., Ltd.

In addition, as an inorganic dispersant which is hardly soluble in water, tricalcium phosphate, calcium carbonate, titanium oxide, colloidal silica and hydroxyapatite may be used.

Moreover, the dispersed droplets may be stabilized with a polymeric protective colloid. Examples of the polymeric protective colloid include: an acid such as acrylic acid, methacrylic acid, α-cyanoacrylic acid, α-cyanomethacrylic acid, itaconic acid, crotonic acid, fumaric acid, maleic acid, and maleic anhydride; (meth)acrylic monomer having a hydroxyl group such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic ester, diethylene glycol monomethacrylic ester, glycerine monoacrylic ester, glycerine monomethacrylic ester, N-methylolacrylamide and N-methylolmethacrylamide; a vinyl alcohol or an ether of vinyl alcohol such as vinyl methyl ether, vinyl ethyl ether and vinyl propyl ether; an ester of vinyl alcohol and a compound having a carboxyl group such as vinyl acetate, vinyl propionate and vinyl butyrate; acrylamide, methacrylamide, diacetone acrylamide and methylol compounds thereof; an acid chloride such as acrylic acid chloride and methacrylic acid chloride; a homopolymer or copolymer of a compound having a nitrogen atom or a heterocyclic ring thereof such as vinylpyridine, vinylpyrrolidone, vinylimidazole and ethyleneimine; a polyoxyethylene compound such as polyoxyethylene, polyoxypropylene, polyoxyethylene alkyl amine, polyoxypropylene alkyl amine, polyoxyethylene alkyl amide, polyoxypropylene alkyl amide, polyoxyethylene nonyl phenyl ether, polyoxyethylene lauryl phenyl ether, polyoxyethylene stearyl phenyl ester and polyoxyethylene nonyl phenyl ester; and a cellulose derivative such as methyl cellulose, hydroxyethyl cellulose and hydroxypropyl cellulose.

Here, when calcium phosphate which is soluble in an acid or alkali is used, for example, as a dispersion stabilizer, calcium phosphate is removed from the particles by dissolving the calcium phosphate with an acid such as hydrochloric acid followed by rinsing. It may also be removed by an operation such as decomposition by an enzyme.

In using a dispersant, the dispersant may remain on the surface of the toner particles. However, it is preferable to remove it by rinsing after an elongation and/or cross-inking reaction in view of the charge property of the toner.

The time for elongation and/or cross-linking reaction is selected based on the reactivity by the combination of the isocyanate group structure comprised in the prepolymer (A) and the amine (B). It is usually 10 minutes to 40 hours, and preferably two hours to 24 hours. The reaction temperature is usually 0° C. to 150° C., and preferably 40° C. to 98° C. Also, a heretofore known catalyst may be used according to requirements. Specific examples thereof include dibutyl tin laurate and dioctyl tin laurate.

As a method for removing the organic solvent from the emulsified dispersoid obtained, the whole system may by slowly heated to completely evaporate and remove the organic solvent in the droplet. It is also possible to spray the emulsified dispersoid in a dry atmosphere to remove completely the water-insoluble organic solvent for toner particle formation and to evaporate and remove the aqueous dispersant as well. Regarding the dry atmosphere in which the emulsified dispersoid is sprayed, a heated gas of air, nitrogen, carbon dioxide or a combustion gas, especially various flow current, which is heated to a temperature above the boiling point of the used solvent having the highest boiling point, is generally used. A rapid treatment by means of a spray dryer, a belt dryer or a rotary kiln sufficiently provides a toner with desired quality.

When the particle distribution in emulsification and dispersion is broad, and rinsing and drying treatments are performed while maintaining the particle distribution, the toner may be classified to the desired particle distribution to arrange the particle distribution.

The classification operation takes place in a liquid by means of a cyclone, a decanter or a centrifuge to remove fine particle portion. It is of course possible to perform the classification operation after obtaining the toner as a powder after drying, but it is preferable to perform it in a liquid in terms of efficiency. The unwanted fine particles or coarse particles obtained may be returned to the kneading process and used again for the particle formation. In that case, the fine particles or coarse particles can be wet.

The dispersant used is preferably removed as much as possible from the obtained dispersion. This is preferably done simultaneously with the above-mentioned classification operation.

By mixing the toner powder obtained after drying with heterogeneous particles such as releasing agent particles, charge controller particles and fluidizer particles and by applying a mechanical impulse force to the mixed powder, the heterogeneous particles are fixed and fused on the surface of the toner powder, and the desorption of the heterogeneous particles from the surface of the obtained composite particles may be prevented.

Specifically, there are methods available such as applying an impulse force to the mixture by means of blades rotating at a high speed. Another method available is to introduce and accelerate the mixture in a high speed flow and have the particles or composite particles collide with each other or to an appropriate collision plate. Examples of the apparatus include Angmill manufactured by Hosokawa Micron Corporation, an apparatus that an I-type mill, manufactured by Nippon Pneumatic Mfg. Co., Ltd., is rebuilt for lower powdering air pressure, HYBRIDIZATION SYSTEM manufactured by NARA MACHINERY CO., LTD., Kryptron System manufactured by Kawasaki Heavy Industries, Ltd. and an automatic mortar.

(Developer)

The developer of the present invention includes at least the toner of the present invention, and it further includes other components appropriately selected such as carrier. The developer may be a one-component developer or a two-component developer; however, the two-component developer is preferable in terms of improved lifetime in case of using the toner in a high-speed printer which is compliant with the recent enhancement in the information-processing speed.

Regarding the one-component developer using the toner of the present invention, the fluctuation in the toner particle diameter is minimal even when the toner inflow and outflow are balanced. The toner filming to a developing roller and the toner adhesion to members such as blade for thin-film formation do not occur. Therefore, the favorable and stable developing properties and image quality may be achieved even in a long-term usage (agitation) of the developing unit. Also, regarding the two-component developer using the toner of the present invention, the fluctuation in the toner particle diameter is minimal even when the toner inflow and outflow are balanced, and the favorable and stable developing properties may be achieved even in a long-term agitation in the developing unit.

The carrier is not particularly restricted and can be selected according to applications. The carrier preferably contains a core and a resin layer that coversthecore.

The material for the core is not particularly restricted and can be appropriately selected from heretofore known materials. Preferable examples thereof include a manganese-strontium (Mn—Sr) material and a manganese-magnesium (Mn—Mg) material of 50 emu/g to 90 emu/g. A highly-magnetizing material such as iron powder of 100 emu/g or more and magnetite of 75 emu/g to 120 emu/g is preferable in terms of assuring the image density. A weakly-magnetized material such as copper-zinc (Cu—Zn) material of 30 emu/g to 80 emu/g is preferable since it softens the contact with a photoconductor on which the toner has developed a magnetic brush and is advantageous in terms of high image quality. These may be used alone or in combination of two or more.

The particle diameter of the core is, on an average particle diameter or a volume-average particle diameter D₅₀, preferably 10 μm to 200 μm, and more preferably 40 μm to 100 μm.

When the average particle diameter or the volume-average particle diameter D₅₀ is less than 10 μm, the ratio of fine powder increases in the distribution of the carrier particles, and carrier dispersal may occur due to the decrease in the degree of magnetization per one particle. When it exceeds 200 μm, the specific surface area decreases to cause toner dispersal. In a full-color printing with many solid portions, especially the reproduction of the solid portions may degrade.

The material for the resin layer is not restricted and can be selected appropriately from heretofore known resins according to applications. Examples thereof include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and an acrylic monomer, copolymers of vinylidene fluoride and vinylidene fluoride, fluoroterpolymers such as terpolymer of tetrafluoroethylene, vinylidene fluoride and nonfluorinated monomer and silicone resins. These may be used alone or in combination of two or more.

Examples of the amino resins include a urea-formaldehyde resin, a melamine resin, a benzoguanamine resin, a urea resin, a polyamide resin and an epoxy resm. Examples of the polyvinyl resins include an acrylic resin, a polymethylmethacrylate resin, a polyacrylonitrile resin, a polyvinyl acetate resin, a polyvinyl alcohol resin and a polyvinyl butyral resin. Examples of the polystyrene resins include a polystyrene resin and a styrene-acrylic copolymer resin. Examples of the halogenated olefin resins include a polyvinyl chloride. Examples of the polyester resins include a polyethylene terephthalate resin and polybutylene terephthalate resin.

The resin layer may optionally include a conductive powder according to requirements, and examples of the conductive powder include metal powder, carbon black, titanium oxide, tin oxide and zinc oxide. The average particle diameter of these conductive powders is preferably 1 pm or less. When the average particle diameter exceeds 1 pm, it may be difficult to control the electric resistance.

The resin layer may be formed, for example, by the following steps. First, a coating solution is prepared by dissolving a resin such as the silicone resin in a solvent. Then, the coating solution is uniformly applied and dried on the surface of the core by means of a heretofore coating method followed by baking. Examples of the coating method include the dipping method, the spray method and the brush coating method.

The solvent is not particularly restricted and can be appropriately selected according to applications. Examples thereof include toluene, xylene, methyl ethyl ketone, methyl isobutyl ketone and cellosolve.

The baking is not particularly restricted, and it can be external heating or internal heating. Examples of baking include a method with a fixed electric furnace, a fluid electric furnace, a rotary electric furnace and a burner furnace and a method with a microwave.

The quantity of the carrier in the resin layer is preferably 0.01% by mass to 5.0% by mass.

When the quantity is less than 0.01% by mass, there are occasions that the resin may not be formed uniformly on the surface of the core. The quantity exceeding 5.0% by mass excessively thickens the resin layer, causing the granulation among carrier particles, and therefore, uniform carrier particles may not be obtained.

When the developer is the two-component developer, the content of the carrier in the two-component developer is not particularly restricted and can be appropriately selected according to applications. For example, it is preferably 90% by mass to 98% by mass, and more preferably 93% by mass to 97% by mass.

The mixing ratio of the toner of the two-component developer to the carrier is, in general, one part by mass to 10.0 parts by mass of the toner per 100 parts of the carrier.

The present invention provides excellent effects as follows. By giving an acid treatment to the pigment surface and by maintaining the acid value and the amine value of the dispersant within certain ranges, the dispersibility of the colorant improves, and hence the color developing property of the toner and the OHP optical transparency improve. Also, it further enhances the colorant dispersion stability in the colorant dispersion, the storage stability of the colorant dispersion and the efficiency of the particle preparation, and moreover the degradation of the charge property which gives an adverse effect in using a pigment dispersant may be avoided. Moreover, the present invention provides a broad selection of resins and colorants, and the decomposition of the pigment dispersion system may be prevented by the addition of other additives such as wax. At the same time, particles are granulated by dissolving or dispersing the resin and the colorant in an organic solvent in which the toner constituent resin is soluble and by dispersing an oil-phase component in an aqueous medium; therefore, the difference in the affinity between the colorant and the oil-phase component and between the colorant and the aqueous medium causes the colorant particles to disperse uniformly within the toner particles, which reduces the amount of the colorant exposed on the toner surface. Furthermore, the shapes of the particles are controllable, and it is easy to ensphere the particles.

Therefore, the toner obtained by means of this manufacturing method has the superior charge property, flowability, stability and transfer ability. Moreover, by applying this toner to the developer, an image having the favorable charge property, favorable image quality and superior OHP optical transparency may be formed in an image forming method that forms a latent image.

(Toner Container)

A toner container of the present invention contains inside the toner and the developer of the present invention.

The container is not particularly restricted and can be appropriately selected from heretofore known containers. A container having a toner container body and a cap is given as a preferable example.

Regarding the toner container body, the size, shape, structure and material are not particularly restricted and can be appropriately selected according to applications. For example, the shape is preferably cylindrical. It is particularly preferable that the inner peripheral surface is patterned so that the toner as the content is transferred to the outlet by rotating the container and that a part of or the whole spiral has a bellows function.

The material of the toner container body is not particularly restricted, and those with dimensional accuracy are preferable. For example, resins are favorable. Among these resins, favorable examples include a polyester resin, a polyethylene resin, a polypropylene resin, a polystyrene resin, a polyvinyl chloride resin, a polyacrylic resin, a polycarbonate resin, an ABS resin and a polyacetal resin.

The toner container of the present invention provides simplicity in storage and transfer as well as superior handle ability. It may be suitably used for toner supply by detachably attaching it to a process cartridge and an image forming apparatus of the present invention described hereinafter.

(Process Cartridge)

A process cartridge of the present invention includes at least a latent electrostatic image bearing member which bears a latent electrostatic image and a developing means which forms a visible image by developing with the developer the latent electrostatic image borne on the latent electrostatic image bearing member, and it further includes other means such as charging unit, exposing unit, transferring means, cleaning means and discharging means appropriately selected according to requirements.

The developing means includes at least a developer container that contains the toner or the developer of the present invention and a developer bearing member which bears and transfers the toner or the developer contained in the developer container, and it may firther include, for example, a thickness regulation member for regulating the thickness of the toner layer that the member bears.

The process cartridge of the present invention may be detachably provided on various electrophotographic apparatuses, facsimiles and printers, and preferably, it is detachably provided on an image forming apparatus of the present invention described hereinafter.

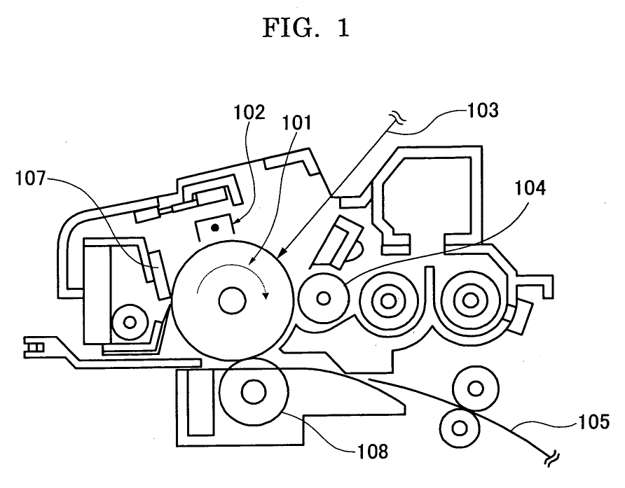

The process cartridge, for example as shown in FIG. 1, houses a photoconductor 101. It also includes a charging unit 102, a developing means 104, a cleaning means 107 and a transferring means 108, and it further includes other members according to requirements. In FIG. 1, the codes 103 and 105 indicate an exposure light by an exposing unit and a recording medium, respectively.

As the photoconductor 101, an apparatus similar to an image forming apparatus described hereinafter may be used. Any charging member is used as the charging unit 102.

Next, an image forming process by means of the process cartridge shown in FIG. 1 is illustrated. A latent electrostatic image corresponding to an exposure image is formed on the surface of the photoconductor 101, which is rotating in the direction of the arrow, by the charge from the charging means 102 and exposure 103 from an exposing means (not shown). This latent electrostatic image is toner developed in the developing means 104, and the toner development is transferred to the recording medium 105 by the transferring means 108. Next, the photoconductor surface after the image transfer is cleaned with the cleaning means 107 and further discharged by a discharging means (not shown) The above operations are repeated again.

Regarding the image forming apparatus of the present invention, components such as latent electrostatic image bearing member, developing unit and cleaning unit are integrated to form a process cartridge, and this unit may be detachably attached to the apparatus body. Also, at least any one of the charging unit, the image exposing unit, the developing unit, the transferring or separating unit and the cleaning unit is supported with the latent electrostatic image bearing member to form the process cartridge as a single unit which can be detachably attached to the apparatus body, and the unit may have a detachable configuration by a guiding means such as rail on the apparatus body.

(Image Forming Apparatus and Image Forming Method)

An image forming apparatus of the present invention contains a latent electrostatic image bearing member, a latent electrostatic image forming means, a developing means, a transferring means and a fixng means, and it further contains other means appropriately selected according to requirements such as discharging means, cleaning means, recycling means and controlling means.

An image forming method of the present invention contains a latent electrostatic image forming process, a developing process, a transferring process and a fixing process, and it further contains other processes appropriately selected according to requirements such as discharging process, cleaning process, recycling process and controlling process.

The image forming method of the present invention may be favorably performed by means of the image forming apparatus of the present invention. The latent electrostatic image forming process may be performed by the latent electrostatic image forming means, the developing process may be performed by the developing means, the transferring process may be performed by the transferring means, the fixing process may be performed by the fixing means, and the other process may be performed by the other means.

Latent Electrostatic Image Forming Process and Latent Electrostatic Image Forming Means

The latent electrostatic image forming process is a process to form a latent electrostatic image on the latent electrostatic image bearing member.

The latent electrostatic image bearing member (photoconductor) is not restricted in terms of the material, shape, structure and size, and it can be appropriately selected from heretofore known photoconductors. The shape of a drum is favorable. Examples of the material include an inorganic photoconductor such as amorphous silicon and selenium and an organic photoconductor such as polysilane and phthalopolymethine. Among these, amorphous silicon is preferable in terms of long lifetime.

The latent electrostatic image may be formed, for example, by charging uniformly the surface of the latent electrostatic image bearing member followed by imagewise exposure, which may be performed by the latent electrostatic image forming means. The latent electrostatic image forming means houses at least a charging unit that uniformly charges the surface of the latent electrostatic image bearing member and an exposing unit that performs an imagewise exposure.

The charging may be performed, for example, by applying an electric potential on the surface of the latent electrostatic image bearing member with the charging unit.

The charging unit is not particularly restricted and can be appropriately selected according to applications. Examples thereof include a contact charging unit, which itself is heretofore known, having a conductive or semiconductive roll, a brush, a film or a rubber blade; and a noncontact charging unit utilizing corona discharge such as corotron and scorotron.

The exposure may be performed, for example, by exposing imagewise the surface of the latent electrostatic image bearing member with the exposing unit.

The exposing unit is not particularly restricted as long as it can perform an imagewise exposure as intended on the surface of the latent electrostatic image bearing member charged by the charging unit, and it can be appropriately selected according to applications. Examples of the exposing unit include a copying optical system, a rod lens array system, a laser optical system and liquid crystal shutter optical system.

In the present invention, the back-exposure method may be adopted in which an exposure is performed imagewise from the back side of the latent electrostatic image bearing member.

Developing Process and Developing Means

The developing process is a process to develop the latent electrostatic image using the toner or the developer of the present invention to form a visible image.

The formation of the visible image may be performed by developing the latent electrostatic image using the toner or the developer of the present invention, and it may be performed by the developing means.

The developing means is not particularly restricted as long as it can perform a development using the toner or the developer of the present invention, and it can be appropriately selected from heretofore known developing means. For example, a preferable developing means contains the toner or the developer of the present invention and includes a developing unit which can impart the toner or the developer in a contact or noncontact manner to the latent electrostatic image. A developing unit which provides the toner container of the present invention is more preferable.

The developing unit may be of a dry development or a wet development. It may also be a monochrome developing unit or a multi-color developing unit. For example, a developer having an agitator that frictions and agitates the toner or the developer of the present invention for electrification and a rotatable magnet roller is preferable.

In the developing unit, for example, the toner and the carrier are mixed and agitated, which causes a friction to charge the toner and maintains the charged toner on the surface of the rotating magnet roller in a state of a chain of magnetic particles, and a magnetic brush is formed. The magnet roller is arranged near the latent electrostatic image bearing member, i.e. photoconductor; therefore, a part of the toner constituting the magnetic brush formed on the surface of the magnetic roller transfers to the surface of the latent electrostatic image bearing member, i.e. photoconductor, due to electric attraction. As a result, the latent electrostatic image is developed by the toner, and a visible image by the toner is formed on the surface of the latent electrostatic image bearing member, i.e. photoconductor.

The developer contained in the developing unit is the developer of the present invention including the toner, and it may be the one-component developer or the two-component developer. The toner included in the developer is the toner of the present invention.

Transferring Process and Transferring Means

The transferring process is a process to transfer the visible image to a recording medium. The transferring process preferably has an aspect that with an intermediate transferring member, it performs a primary transfer to transfer the visible image to the intermediate transferring member followed by a secondary transfer to transfer the visible image to the recording medium. An aspect which includes a primary transferring process that transfers the visible image to the intermediate transferring member to form a complex transfer image and a secondary transferring process that transfers the complex transfer image to the recording medium using a toner having two or more colors or preferably a full-color toner is more preferable.

The transfer of the visible image may be performed by charging the latent electrostatic image bearing member, i.e. photoconductor, using a transfer charging unit, and it may be performed by the transferring means. The transferring means preferably has an aspect that includes a primary transferring means that transfers a visible image to an intermediate transferring member to form a complex transfer image and a secondary transferring means that transfers the complex transfer image to a recording medium.

The intermediate transferring member is not particularly restricted and can be appropriately selected according to applications from heretofore known transferring member. Favorable examples include a transfer belt.

The transferring means, i.e. the primary transferring means and the secondary transferring means, preferably contain at least a transferring unit that strips and charges the visible image formed on the latent electrostatic image bearing member, i.e. photoconductor, to the side of the recording medium. There may be one transferring means, or there may be two or more.

Examples of the transferring unit include a corona transferring unit by corona discharge, a transfer belt, a transfer roller, a pressure transfer roller and an adhesive transferring unit.

Also, the typical recording medium is plain paper, but it is not particularly restricted as long as an unfixed image after developing can be transferred. It can be appropriately selected according to applications, and a PET base for OHP may be used.

The fixing process is a process to fix the visible image transferred to the recording medium by means of a fixing apparatus. It may be performed every time the toner of each color is transferred to the recording medium, or it may be performed at once when the toner of all the colors is laminated.

The fixing apparatus is not particularly restricted and can be selected appropriately according to applications. A heretofore known hot-pressing means is favorable. Examples of the hot-pressing means include a combination of a heat roller and a pressure roller and a combination of a heat roller, a pressure roller and an endless belt.

In general, the heating in the hot-pressing means is preferably 80° C. to 200° C.

In the present invention, a heretofore known optical fixing unit, for example, may be used along with or in place of the fixing process and the fixing means according to applications.

The discharging process is a process to discharge the latent electrostatic image bearing member by applying a discharging bias, and it may be favorably performed by a discharging means.

The discharging means is not particularly restricted as long as the discharging bias is applied to the latent electrostatic image bearing member. It can be appropriately selected from heretofore known discharging units, and favorable examples include a discharge lamp.

The cleaning process is a process to remove the residual toner on the latent electrostatic image bearing member, and it may be favorably performed by a cleaning means.

The cleaning means is not particularly restricted as long as it can remove the electrophotographic toner remaining on the latent electrostatic image bearing member, and it can be appropriately selected from heretofore known cleaners. Favorable examples thereof include a magnetic brush cleaner, a static brush cleaner, a magnetic roller cleaner, a blade cleaner, a brush cleaner and a web cleaner.

The recycling process is a process to recycle the electrophotographic toner removed in the cleaning process to the developing means, and it may be favorably performed by a recycling means.

The recycling means is not particularly restricted, and a heretofore known transporting means may be used.

The controlling process is a process to control each of the above-mentioned processes, and it may be favorably performed by a controlling means.

The controlling means is not particularly restricted as long as it can control the behavior of each of the means. Examples thereof include equipment such as sequencer and computer.

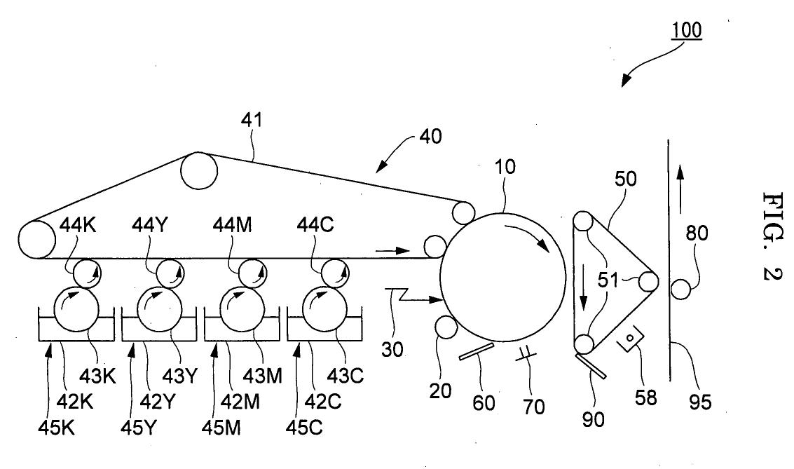

An aspect that implements the image forming method of the present invention by the image forming apparatus of the present invention is illustrated with reference to FIG. 2. An image forming apparatus 100 shown in FIG. 2 provides: a photoconductor drum 10 as the latent electrostatic image bearing member (hereinafter referred to as a photoconductor 10), a charge roller 20 as the charge unit, an exposure apparatus 30 as the exposing unit, a developing apparatus 40 as the developing means, an intermediate transferring member 50, a cleaning apparatus 60 as the cleaning means having a cleaning blade and a discharge lamp 70 as the discharging means.

The intermediate transferring member 50 is an endless belt, and it is designed to be movable in the direction of the arrow by means of three rollers 51, which are arranged inside and spanning the belt. A part of the rollers 51 also functions as a transfer bias roller which can apply a predefined transfer bias (primary transfer bias) to the intermediate transferring member 50. The intermediate transferring member 50 has a cleaning apparatus 90 with a cleaning blade arranged in its vicinity and a transfer roller 80 as the transferring means which can apply a transfer bias for the transfer (secondary transfer) of a developing image (toner image) to transfer paper 95 as a final transfer member arranged in the opposite position. Around the intermediate transferring member 50, a corona charging unit 58 for charging the toner image on the intermediate transferring member 50 is placed in the rotating direction of the intermediate transferring member 50 between the contact point of the photoconductor 10 and the intermediate transferring member 50 and the contact point of the intermediate transferring member 50 and the transfer paper 95.

The developing apparatus 40 is composed of a developing belt 41 as the developer bearing member as well as a black developing unit 45K, a yellow developing unit 45Y, a magenta developing unit 45M and a cyan developing unit 45C arranged in parallel along the developing belt 41. Here, the black developing unit 45K contains a developer containing part 42K, a developer supply roller 43K and a developer roller 44K. The yellow developing unit 45Y contains a developer containing part 42Y, a developer supply roller 43Y and a developer roller 44Y. The magenta developing unit 45M contains a developer containing part 42M, a developer supply roller 43M and a developer roller 44M. The cyan developing unit 45C contains a developer containing part 42C, a developer supply roller 43C and a developer roller 44C. Also, the developing belt 41 is an endless belt, spanned rotatably over multiple belt rollers, and a part thereof is in contact with the photoconductor 10.

In the image forming apparatus 100 shown in FIG. 2, for example, the charge roller 20 uniformly charges the photoconductor drum 10. The exposure apparatus 30 exposes imagewise to form a latent electrostatic image on the photoconductor drum 10. The toner is provided from the developing apparatus 40 to develop and form a visible image (toner image). The visible image (toner image) is transferred on the intermediate transferring member 50 by an electric voltage applied by the roller 51 (primary transfer), and it is further transferred on the transfer paper 95 (secondary transfer). As a result, a transfer image is formed on the transfer paper 95. Here, the residual toner on the photoconductor 10 is removed by the cleaning apparatus 60, and the charge over the photoconductor 10 is once discharged by the discharge lamp 70.

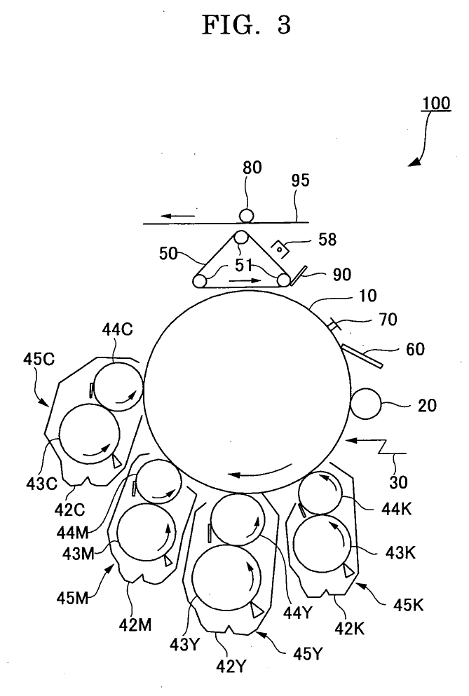

Another aspect to implement the image forming method of the present invention by means of the image forming apparatus of the present invention is illustrated with reference to FIG. 3. An image forming apparatus 100 shown in FIG. 3 has a similar configuration as the image forming apparatus 100 shown in FIG. 2 except that the developing belt 41 in the image forming apparatus 100 in FIG. 2 is not provided and that the black developing unit 45K, the yellow developing unit 45Y, magenta developing unit 45M and the cyan developing unit 45C are arranged directly in the opposite side of a photoconductor 10, and it shows similar working effects. Here, the members in FIG. 3 equivalent to those in FIG. 2 are indicated with the same codes.

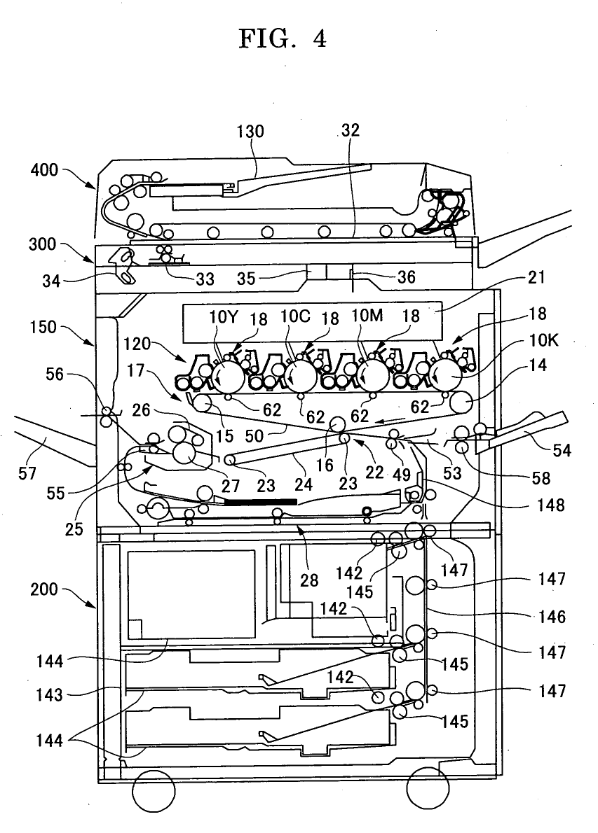

Another aspect to implement the image forming method of the present invention by means of the image forming apparatus of the present invention is illustrated with reference to FIG. 4. A tandem image forming apparatus shown in FIG. 4 is a tandem color-image forming apparatus. The tandem image forming apparatus has a copying apparatus body 150, a paper feed table 200, a scanner 300 and an automatic document feeder (ADF) 400.

In the copying apparatus body 150, an intermediate transferring member 50 is located as an endless belt at the center. The intermediate transfer member 50 is spanned over support rollers 14, 15 and 16 and rotatable clockwise in FIG. 4. Near the support roller 15, an intermediate transferring member cleaning apparatus 17 is placed to remove the residual toner on the intermediate transferring member 50. On the intermediate transferring member 50 spanned by the support roller 14 and the support roller 15, a tandem developing unit 120 is placed, opposite to which four image forming means 18 of yellow, cyan, magenta and black are arranged in parallel along the transporting direction. Near the tandem developing unit 120, an exposure apparatus 21 is placed. On the side of the intermediate transferring member 50 opposite to the side of the tandem developing unit 120, a secondary transferring apparatus 22 is placed. In the secondary transferring apparatus, a secondary transfer belt 24 as an endless belt is spanned over a pair of rollers 23, and transfer paper transported on the secondary transfer belt 24 and the intermediate transferring member 50 can contact with each other. Near the secondary transferring apparatus 22, a fixing apparatus 25 is placed. The fixing apparatus 25 has a fixing belt 26 as an endless belt and a pressure roller 27 arranged such that it is being pressed thereby.

Here, near the secondary transfer apparatus 22 and the fixing apparatus 25 of the tandem image forming apparatus, a sheet reversing apparatus 28 is placed to reverse transfer paper so that images are formed on both sides of the transfer paper.

Next, the formation of a full-color image, i.e. color copy, by means of the tandem image forming apparatus is illustrated. That is, first of all, an original document is placed on a document table 130 of the automatic document feeder (ADF) 400, or the original document is placed on a contact glass 32 of the scanner 300 by opening the automatic document feeder 400, which is then closed.

A start key (not shown) is pressed, and the scanner 300 is activated to drive a first carriage 33 and a second carriage 34 after the document is fed and transported onto the contact glass 32 when the original document has been placed on the automatic document feeder 400, or on the other hand immediately when the original copy is placed on the contact glass 300. At this time, the light from the light source is irradiated by the first carriage 33 as well as the light reflected from the document surface is reflected by a mirror in the second carriage 34, which is received by a reading sensor 36 through a lens 35. As a result, a color document (color image) is read as black, yellow, magenta and cyan image information.

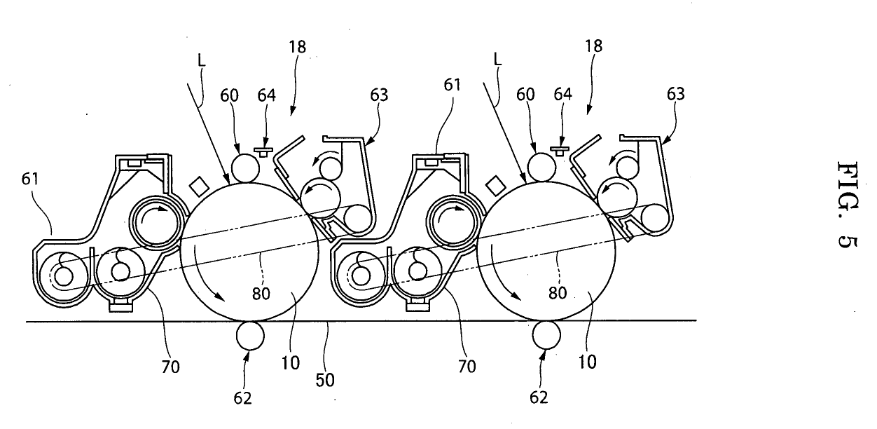

Each of the black, yellow, magenta and cyan image information is transmitted to each image forming means 18 (black image forming means, yellow image forming means, magenta image forming means and cyan image forming means), and black, yellow, magenta and cyan toner images are formed in the respective image forming means. That is, as illustrated in FIG. 5, each image forming means 18 (black image forming means, yellow image forming means, magenta image forming means and cyan image forming means) in the tandem image forming apparatus has: a photoconductor 10 (black photoconductor 10K, yellow photoconductor 10Y, magenta photoconductor 10M and cyan photoconductor 10C); a charging unit 60 that uniformly charges the respective photoconductor; an exposing unit that exposes imagewise the photoconductor (L in FIG. 5) corresponding to the respective color image based on the color image information and forms a latent electrostatic image of the respective color image on the photoconductor; a developing unit 61 that develops the latent electrostatic image using the respective color toner (black toner, yellow toner, magenta toner and cyan toner) and forms a toner image of the respective color toner; a transfer charging unit 62 for transferring the toner image on the image transferring member 50; a photoconductor cleaning apparatus 63; and a discharging unit 64. Therefore, based on the image information of the respective color, an image of a single color (black image, yellow image, magenta image and cyan image) may be formed. The black image formed on the black photoconductor 10K, the yellow image formed on the yellow photoconductor 10Y, the magenta image formed on the magenta photoconductor 10M and the cyan image formed on the cyan photoconductor 10C as above are sequentially transferred on the intermediate transferring member 50, which is rotationally shifted by means of the support rollers 14, 15 and 16 (primary transfer). Then, a composite color image (color transfer image) is formed by superimposing the black image, the yellow image, the magenta image and the cyan image on the intermediate transferring member 50.

On the other hand, on the paper feed table 200, one of the feed rollers 142 is selectively rotated to let out a sheet of recording paper from one of the multi-stage paper feeding cassettes 144 provided in a paper bank 143. The sheet is separated one by one and delivered to the paper feeding path 146 by separation rollers 145. It is then transported and guided by conveyance rollers 147 to a paper-feeding path 148 in the copying machine body 150 and finally stopped by striking to a paper stop roller 49. Here, the paper stop roller 49 is generally used grounded, but it may be used in the state a bias is applied for paper-powder removal. Then, the paper stop roller 49 is rotated with precise timing with the composite color image (color transfer image) combined on the intermediate transferring member 50 to feed the sheet (recording paper) between the intermediate transferring member 50 and the secondary transferring apparatus 22, and by transferring the composite color image (color transfer image) on the sheet (recording paper) by means of the secondary transferring apparatus 22 (secondary transfer), a color image is transferred and formed on the sheet (recording paper). Here, the residual toner on the intermediate transferring member 50 after the image transfer is removed by means of the intermediate transferring member cleaning apparatus 17.

The sheet (recording paper) on which a color image is transferred and formed is transported and delivered by the secondary transferring apparatus 22 to the fixing apparatus 25, and in the fixing apparatus 25, the composite color image (color transfer image) is fixed on the sheet (recording paper) under heat and pressure. Then, the sheet (recording paper) is switched by a switching claw 55, discharged by a delivery roller 56 and stacked on a copy receiving tray 57. Alternatively, the sheet (recording paper) switched by the switching claw 55 is reversed by the sheet reversing apparatus 28 and guided again to the transferring position for recording an image on the back side. It is then discharged by the delivery roller 56 and stacked on the copy receiving tray 57.

The present invention is illustrated in more detail with reference to examples and comparative examples given below, but these are not to be construed as limiting the present invention but to facilitate understanding of the present invention.

### EXAMPLE 1

Synthesis of Resin Particle Emulsion

In a reaction vessel equipped with a stirrer and a thermometer, 683 parts of water, 11 parts of a sodium salt of methacrylic acid ethylene oxide adduct sulfate ester (ELEMINOL RS-30, manufactured by Sanyo Chemical Industries, Ltd.), 83 parts of styrene, 83 parts of methacrylic acid, 110 parts of butyl acrylate and one part of ammonium persulfate were charged and stirred at 400 rpm for 15 minutes to obtain a white emulsion. The emulsion was heated until the temperature in the system reached 75° C. and reacted for five hours. Furthermore, 30 parts of a 1-% aqueous solution of ammonium persulfate was added, and the mixture was aged at 75° C. for five hours to obtain an aqueous dispersion of a vinyl resin (copolymer of styrene-methacrylic acid-butyl acrylate-sodium salt of sulfate ester of methacrylic acid ethylene oxide adduct), Resin Particle Dispersion 1. The volume average particle diameter of Resin Particle Dispersion 1 was measured by a laser diffraction/scattering particle size distribution analyzer LA-920 manufactured by HORIBA, Ltd. and found to be 105 nm. A part of Resin Particle Dispersion 1 was dried to isolate the resin component. The Tg of the resin component was 59° C., and the mass average molecular weight was 150,000.

Preparation of Aqueous Phase

Nine hundred ninety (990) parts of water, 83 parts of Resin Particle Dispersion 1, 37 parts of a 48.5-% aqueous solution of sodium dodecyldiphenyl ether disulfonate (ELEMINOL MON-7, manufactured by Sanyo Chemical Industries, Ltd.) and 90 parts of ethyl acetate were mixed and stirred to obtain a milky white liquid, which was hereinafter referred to as Aqueous Phase 1.

Synthesis of Low-Molecular Polyester

In a reaction vessel equipped with a condenser tube, an agitator and a nitrogen introduction tube, 229 parts of bisphenol A ethylene oxide 2 mole adduct, 529 parts of bisphenol A propylene oxide 3 mole adduct, 208 parts of terephthalic acid, 46 parts of adipic acid and two parts of dibutyl tin oxide were charged and reacted at a normal pressure and a temperature of 230° C. over eight hours. After it was further reacted at a reduced pressure of 10 mmHg to 15 mmHg over five hours, 44 parts of trimellitic anhydride was added to the reaction vessel. The mixture was reacted at a normal pressure and a temperature of 180° C. over two hours to obtain low-Molecular Polyester 1. Low-Molecular Polyester 1 had a number-average molecular weight of 2,500, a mass-average molecular weight of 6,700, a Tg of 43° C. and an acid value of 25 mg KOH/g.

Synthesis of Intermediate Polyester

In a reaction vessel equipped with a condenser tube, an agitator and a nitrogen introduction tube, 682 parts of bisphenol A ethylene oxide 2 mole adduct, 81 parts of bisphenol A propylene oxide 2 mole adduct, 283 parts of terephthalic acid, 22 parts of trimellitic anhydride and two parts of dibutyl tin oxide were charged and reacted at a normal pressure and a temperature of 230° C. over eight hours. It was further reacted at a reduced pressure of 10 mmHg to 15 mmHg over five hours to obtain Intermediate Polyester 1. Intermediate Polyester 1 had a number average molecular weight of 2,100, a mass average molecular weight of 9,500, a Tg of 55° C., an acid value of 0.5 mg KOH/g and a hydroxyl value of 51 mg KOH/g.

Next, in a reaction vessel equipped with a condenser tube, an agitator and a nitrogen introduction tube, 410 parts of Intermediate Polyester 1, 89 parts of isophorone diisocyanate and 500 parts of ethyl acetate were charged and reacted at a temperature of 100° C. over five hours to obtain Prepolymer 1. Prepolymer 1 had a free isocyanate content of 1.53% by mass.

Synthesis of Ketimine

In a reaction vessel equipped with a stirrer and a thermometer, 170 parts of isophorone diamine and 75 parts of methyl ethyl ketone were charged and reacted at a temperature of 50° C. over five hours to obtain Ketimine Compound 1. Ketimine Compound 1 had an amine value of 418 mg KOH/g.

Pigment Treatment

In a mixture of 1,300 parts of water and 290 parts of 35-% hydrochloric acid, 182.7 parts of 2-methoxy-4-nitroaniline and 5.1 parts of 2-nitro-4-methylanline were added and agitated. It was then cooled to 0° C., and 80 parts of sodium nitrite was added for diazotization. Separately, 241.8 parts of 2-methoxyacetoacetoanilide was added to 5,000 parts of water and dissolved with 48 parts of sodium hydroxide; a mixture of 196 parts of acetic acid and 196 parts of water was further added for precipitation to obtain a suspension of a coupling component. While agitating well the transparent diazo solution, the acetic acid suspension of the coupling component was poured and added at a temperature of 15° C. within one hour and 30 minutes to two hours. After the coupling reaction was completed, a pigment treatment was given using 45 parts of rosin and 13 parts of calcium chloride. The obtained pigment composition was filtered and rinsed to separate a wet pigment paste of yellow azo pigment. The coagulation was dried at 90° C. to obtain a surface-treated pigment.

Synthesis of Master Batch

In a Henschel mixer manufactured by MITSUI MINING COMPANY, LIMITED, 1,200 parts of water, 540 parts of C. I. Pigment Yellow 74 which is the acid-treated pigment of the product manufactured by SANYO COLOR WORKS, Ltd., 108 parts of AJISPER PB 822 as a dispersant having an amine value of 13 mg KOH/g and an acid value of 16 mg KOHIg manufactured by Ajinomoto Fine-Techno Co., Inc. and 1,200 parts of a polyester resin were added and mixed. After it was kneaded using a two-roll mill at a temperature of 150° C. over 30 minutes, the mixture was rolled, cooled and then pulverized with a pulverizer to obtain Master Batch 1.

Preparation of Oil Phase

In a vessel with a stirrer and a thermometer, 378 parts of Low-Molecular Polyester 1, 110 parts of carnauba wax, 22 parts of CCA (salicylic acid metal complex E-84, manufactured by Orient Chemical Industries, Ltd.) and 947 parts of ethyl acetate were charged. After it was heated to 80° C. under agitation and maintained for five hours while keeping the temperature at 80° C., the mixture was cooled to 30° C. in one hour. Next, 500 parts of Master Batch 1 and 500 parts of ethyl acetate were charged in a vessel which was mixed for one hour to obtain Raw Material Solution 1.

In a vessel, 1,324 parts of Raw Material Solution 1 was transferred, and the Pigment Red and the wax were dispersed in three passes using a bead mill, Ultraviscomill manufactured by Aimex Co., Ltd., filled at 80% by volume with 0.5-mm zirconia beads under conditions of a liquid feeding rate of 1 kg/hr and a disk circumferential velocity of 6 m/sec. Next, 1,324 parts of 65-% ethyl acetate solution of Low Molecular Polyester 1 was added, and the mixture was dispersed in a single pass under the same conditions as above to obtain Pigment-Wax Dispersion 1. Pigment-Wax Dispersion 1 had a solid concentration of 50% (130° C. and 30 minutes).

Emulsification and Desolvation

In a vessel, 749 parts of Pigment-Wax Dispersion 1, 115 parts of Prepolymer 1 and 2.9 parts of Ketimine Compound 1 were placed and mixed with T.K. HOMO MIXER manufactured by Tokushu Kika Kogyo Co., Ltd. at 5,000 rpm for one minute. Then, 1,200 parts of Aqueous Phase 1 was added to the vessel, and the mixture was mixed with T.K HOMO MIXER at 13,000 rpm for 20 minutes to obtain Emulsified Slurry 1.

In a vessel equipped with an agitator and a thermometer, Emulsified Slurry 1 was introduced and desolvated at 30° C. for eight hours. Then, it was aged at 45° C. for four hours to obtain Dispersed Slurry 1. Dispersed Slurry 1 had a volume average particle diameter of 5.99 μm, a number average particle diameter of 5.70 μm, which were measured by Multisizer II available from Nikkaki Bios Co., Ltd.

Washing and Drying

After 100 parts of Dispersed Slurry 1 was filtered under a reduced pressure:

(1) 100 parts of ion-exchanged water was added to the filter cake, mixed with T.K HOMO MIXER at 12,000 rpm for 10 minutes and then filtered;

(2) 10-% hydrochloric acid was added to the filter cake of (1) such that the pH of the mixture was adjusted to 2.8, mixed with T.K HOMO MIXER at 12,000 rpm for 10 minutes and the filtered; and

(3) the operation of adding 300 parts of ion-exchanged water was added to the filter cake of (2) and mixing at 12,000 rpm for 10 minutes followed by filtration was repeated twice to obtain Filter Cake 1.

Filter Cake 1 was dried in a circulating air drier at 45° C. for 48 hours and then sieved with a 75-μm mesh sieve to obtain Toner 1.

### EXAMPLE 2

Toner 2 was obtained in the same manner as Example 1 except that Master Batch 2 prepared as described below was used instead of Master Batch 1 in Example 1.

Pigment Processing

In a 10-liter kneader, 500 parts of crude copper phthalocyanine blue having a purity of 95% was charged along with 2,000 parts of common salt and 550 parts of diethylene glycol. After the mixture was kneaded at 100° C. for four hours, the mixture was added with 25 parts of natural rosin and further mixed for 30 minutes. The mixture obtained was brought out in 10,000 parts of water and agitated at 80° C. until the common salt and diethylene glycol dissolved. After it was further added with 50 parts of 98-% sulfuc acid and agitated for one hour, the mixture was filtered and washed until it became neutral to obtain a pigment composition in a paste form. This was further dried and pulverized to obtain 490 parts of the pigment composition.

Synthesis of Master Batch

In a Henschel mixer manufactured by MITSUI MINING COMPANY, LIMITED, 1,200 parts of water, 540 parts of C. I. Pigment Blue 15:3 which is the acid-treated product manufactured by Dainichiseika Color & Chemicals Mfg. Co., Ltd., 108 parts of AJISPER PB 822 as a dispersant having an amine value of 13 mg KOH/g and an acid value of 16 mg KOH/g manufactured by Ajinomoto Fine-Techno Co., Inc. and 1,200 parts of a polyester resin were added and mixed. After it was kneaded using a two-roll mill at a temperature of 150° C. over 30 minutes, the mixture was rolled, cooled and then pulverized with a pulverizer to obtain Master Batch 2.

### EXAMPLE 3

Toner 3 was obtained in the same manner as Example 1 except that Master Batch 3 prepared as described below was used instead of Master Batch 1 in Example 1.

Pigment Processing

After 20.0 parts of 2-amino-5-methylbenzene sulfonic acid was dispersed in 200 parts of water, 22.0 parts of 20-% hydrochloric acid was added. While maintaining the temperature at 0° C., 25.1 parts of a 30-% sodium nitrite solution was delivered by drops to obtain a diazo liquid. Next, 20.6 parts of 2-hydroxynaphthoic acid was dispersed at 60° C. in 242 parts of water, and 11.5 parts of a 48-% sodium hydroxide solution was added to obtain a coupler solution. This coupler solution was cooled to 0° C., and the diazo liquid was delivered by drops into the coupler solution under agitation. After the coupling reaction was completed, the mixture was added with 40 parts of a 10-% solution of sodium salt of rosin and agitated for 60 minutes to obtain a suspension.

In this suspension, a solution in which 18.6 parts of calcium chloride was dissolved in 70 parts of water was added, and the mixture was agitated for 60 minutes to complete a lake reaction. After the completion of the lake reaction, the mixture was agitated for 60 minutes with heating at 80° C. to obtain an aqueous suspension of a calcium lake azo pigment, C. I. Pigment Red 57:1. This suspension was filtered, and the coagulation was dried at 90° C. to obtain a surface-treated pigment.

Synthesis of Master Batch

In a Henschel mixer manufactured by MITSUI MINING COMPANY, LIMITED, 1,200 parts of water, 540 parts of C. I. Pigment Red 57:1, the acid-treated pigment of the product manufactured by DAINIPPON INK AND CHEMICAIS, INCORPORATED, 108 parts of Disperbyk-2001 as a dispersant, having an amine value of 29 mg KOH/g and an acid value of 19 mg KOH/g, manufactured by BYK-Chemie GmbH, and 1,200 parts of a polyester resin were added and mixed. After it was kneaded using a two-roll mill at a temperature of 150° C. over 30 minutes, the mixture was rolled, cooled and then pulverized with a pulverizer to obtain Master Batch 3.

### COMPARATIVE EXAMPLE 1

Toner 4 was prepared in the same manner as Example 1 except that a non-treated pigment was used in Example 1.

### COMPARATIVE EXAMPLE 2

Toner 5 was prepared in the same manner as Example 2 except that a non-treated pigment was used in Example 2.

### COMPARATIVE EXAMPLE 3

Toner 6 was prepared in the same manner as Example 3 except that a non-treated pigment was used in Example 3.

### COMPARATIVE EXAMPLE 4

Toner 7 was prepared in the same manner as Example 1 except that the dispersant was replaced by AJISPER PB-711 having an amine value of 45 mg KOH/g, manufactured by Ajinomoto Fine-Techno Co., Inc., in Example 1.

### COMPARATIVE EXAMPLE 5

Toner 8 was prepared in the same manner as Example 2 except that the dispersant was replaced by AJISPER PB-711 having an amine value of 45 mg KOH/g, manufactured by Ajinomoto Fine-Techno Co., Inc., in Example 2.

### COMPARATIVE EXAMPLE 6

Toner 7 was prepared in the same manner as Example 3 except that the dispersant was replaced by Disperbyk-2000 having an amine value of 4 mg KOH/g, manufactured by BYK-Chemie GmbH, in Example 3.

<Evaluation of Toners>

At a temperature of 28° C. and a relative humidity of 80%, 10 g of each toner obtained was mixed with 100 g of ferrite carrier, and the charge quantity of the toner was measured by the blow-off method. It was observed that the charge distribution at this time was sharp. The particle diameter of the toner was measured by means of COULTER COUNTER TA-II, manufactured by Coulter Electronics, Ltd., with an aperture diameter of 100 μm. The volume average particle diameter and the number average particle diameter were measured by means of the above particle size measuring equipment. The surface profile of the toner was observed with scanning electron microscope.

The image density was measured as follows: an image forming apparatus, imagio Neo 450 manufactured by Ricoh Company, Ltd. was adjusted such that a solid image with a toner of 1.0±0.1 mg/cm² was developed on plain paper and cardboard as transfer paper (Type 6200 manufactured by Ricoh Company, Ltd. and copy print paper 135 manufactured by NBS Ricoh Co., Ltd., respectively), and that the temperature of the fixing belt was variable. A solid image was printed, and the image density was measured with X-Rite manufactured by X-Rite KK This measurement was performed at five points for each color alone, and the average for each color was obtained.

Next, one part of silica, AEROSIL R972 manufactured by NIPPON AEROSIL CO., LTD., was added as an external additive to 100 parts of this toner. The toner having externally added silica was mixed in a sample mill for one minute and fixed without fuser oil for fixing in a remodeled electrophotographic full-color copying machine, imagio Neo 450 manufactured by Ricoh Company, Ltd. to form an OHP fixed image.

The dispersibility of the colorants was examined by observing the toner cross section with transmission electron microscope. More specifically, a toner sample was embedded and cut in an epoxy resin, and the cross section was observed with transmission electron microscope. Transmission electron microphotographs showing the toner particle structure of Example 1 and Comparative Example 1 were compared. An aggregate of the colorant existed in the toner of Comparative Example 1, and there were areas where the colorant did not exist. On the contrary, for the toner of Example 1, the colorant existed umiformly in the toner with no local aggregation of the colorant observed, and it was confirmed that the dispersion state was favorable. The dispersion state of the colorant was verified similarly for the toners of the other Examples and Comparative Examples.

A solid color image was fixed on a transparent sheet for OHP, and the turbidity was measured using a turbidity measuring apparatus. The results of these evaluations are shown in Table 1.

TABLE 1

| | | Toner particle distribution | | | | | | | |
|---|---|---|---|---|---|---|---|---|---|
| | | Mass-average | Number-average | | | | | | |
| | | particle | particle | | | | | | |
| | | diameter | diameter | | Toner Shape | Toner charge quantity (−μC/g) | | | |
| | Toner No. | D₄ (μm) | Dₙ (μm) | D₄/Dₙ | Sphericity | 5 sec. | 1 min. | 10 min. | Turbidity |
| Example 1 | Toner 1 | 4.85 | 4.41 | 1.10 | 0.978 | 30.8 | 32.4 | 32.9 | 4 |
| Example 2 | Toner 2 | 5.11 | 4.82 | 1.06 | 0.984 | 29.4 | 30.5 | 30.3 | 3 |
| Example 3 | Toner 3 | 4.96 | 4.61 | 1.08 | 0.981 | 31.2 | 30.9 | 31.5 | 5 |
| Comparative Example 1 | Toner 4 | 4.62 | 4.40 | 1.05 | 0.977 | 12.5 | 11.2 | 10.8 | 43 |
| Comparative Example 2 | Toner 5 | 4.98 | 4.74 | 1.05 | 0.980 | 10.9 | 12.3 | 11.7 | 22 |
| Comparative Example 3 | Toner 6 | 5.18 | 4.75 | 1.09 | 0.976 | 9.8 | 10.6 | 10.4 | 35 |
| Comparative Example 4 | Toner 7 | 4.78 | 4.31 | 1.11 | 0.983 | 20.7 | 19.8 | 21.3 | 15 |
| Comparative Example 5 | Toner 8 | 4.69 | 4.38 | 1.07 | 0.979 | 18.2 | 19.5 | 22.2 | 12 |
| Comparative Example 6 | Toner 9 | 5.02 | 4.56 | 1.10 | 0.976 | 17.4 | 18.8 | 20.5 | 18 |

The results in Table 1 indicate that the toners for electrophotography of Examples 1 to 3 of the present invention had favorable dispersion of the colorants in the toners, the superior charge property and uniform charge distribution. While a toner dispersed and optimized by an acid-treated pigment and a pigment dispersant having an acid value and an amine value in certain ranges maintains a stable charge quantity, an unoptimized toner has a pigment unevenly distributed near the toner surface and cannot maintain a stable charge quantity because of the effect of the amine site of a dispersant. This is because the amine site of the dispersant adversely affects the electrification of the dispersant depending on the combination of the pigment surface conditions such as acidity and basicity and the dispersant even though high dispersion of the pigment has been achieved. It is also indicated that the toner of Examples 1 to 3 had the superior coloring property and optical transparency after the fixing to an OHP sheet.

### EXAMPLE 4

Synthesis of Resin Particle Emulsion

In a reaction vessel equipped with a stirrer and a thermometer, 683 parts of water, 11 parts of a sodium salt of methacrylic acid ethylene oxide adduct sulfate ester (ELEMINOL RS-30, manufactured by Sanyo Chemical Industries, Ltd.), 83 parts of styrene, 83 parts of methacrylic acid, 110 parts of butyl acrylate and one part of ammonium persulfate were charged and stirred at 400 rpm for 15 minutes to obtain a white emulsion. The emulsion was heated until the temperature in the system reached 75° C. and reacted for five hours. Furthermore, 30 parts of a 1-% by mass aqueous solution of ammonium persulfate was added, and the mixture was aged at 75° C. for five hours to obtain an aqueous dispersion of a vinyl resin, Resin Particle Dispersion 2. The volume average particle diameter of Resin Particle Dispersion 2 was measured by a laser diffraction/scattering particle size distribution analyzer LA-920 manufactured by HORIBA, Ltd. and found to be 105 nm. A part of Resin Particle Dispersion 2 was dried to isolate the resin component. The Tg of the resin component was 59° C., and the mass average molecular weight was 150,000.

Preparation of Aqueous Phase

Nine hundred ninety (990) parts of water, 83 parts of Resin Particle Dispersion 2, 37 parts of a 48.5-% aqueous solution of sodium dodecyldiphenyl ether disulfonate (ELEMINOL MON-7, manufactured by Sanyo Chemical Industries, Ltd.) and 90 parts of ethyl acetate were mixed and stirred to obtain a milky white liquid, which was hereinafter referred to as Aqueous Phase 2.

Synthesis of Low-Molecular Polyester

In a reaction vessel equipped with a condenser tube, an agitator and a nitrogen introduction tube, 229 parts of bisphenol A ethylene oxide 2 mole adduct, 529 parts of bisphenol A propylene oxide 3 mole adduct, 208 parts of terephthalic acid, 46 parts of adipic acid and two parts of dibutyl tin oxide were charged and reacted at a normal pressure and a temperature of 230° C. over eight hours. After it was further reacted at a reduced pressure of 10 mmHg to 15 mmHg over five hours, 44 parts of trimellitic anhydride was added to the reaction vessel. The mixture was reacted at a normal pressure and a temperature of 180° C. over two hours to obtain low-Molecular Polyester 2. Low-Molecular Polyester 2 had a number-average molecular weight of 2,500, a mass-average molecular weight of 6,700, a Tg of 43° C. and an acid value of 25 mg KOH/g.

Synthesis of Intermediate Polyester

In a reaction vessel equipped with a condenser tube, an agitator and a nitrogen introduction tube, 682 parts of bisphenol A ethylene oxide 2 mole adduct, 81 parts of bisphenol A propylene oxide 2 mole adduct, 283 parts of terephthalic acid, 22 parts of trimellitic anhydride and two parts of dibutyl tin oxide were charged and reacted at a normal pressure and a temperature of 230° C. over eight hours. It was further reacted at a reduced pressure of 10 mmHg to 15 mmHg over five hours to obtain Intermediate Polyester 2. Intermediate Polyester 2 had a number average molecular weight of 2,100, a mass average molecular weight of 9,500, a Tg of 55° C., an acid value of 0.5 mg KOH/g and a hydroxyl value of 51 mg KOH/g.

Next, in a reaction vessel equipped with a condenser tube, an agitator 20 and a nitrogen introduction tube, 410 parts of Intermediate Polyester 2, 89 parts of isophorone diisocyanate and 500 parts of ethyl acetate were charged and reacted at a temperature of 100° C. over five hours to obtain Prepolymer 2. Prepolymer 2 had a free isocyanate content of 1.53% by mass.

Synthesis of Ketimine

In a reaction vessel equipped with a stirrer and a thermometer, 170 parts of isophorone diamine and 75 parts of methyl ethyl ketone were charged and reacted at a temperature of 50° C. over five hours to obtain Ketimine Compound 2. Ketimine Compound 2 had an amine value of 418 mg KOH/g.

Pigment Treatment

In a mixture of 1,300 parts of water and 290 parts of 35-% hydrochloric acid, 182.7 parts of 2-methoxy-4-nitroaniline and 5.1 parts of 2-nitro-4-methylaniline were added and agitated. It was then cooled to 0° C., and 80 parts of sodium nitrite was added for diazotization. Separately, 241.8 parts of 2-methoxyacetoacetoanilide was added to 5,000 parts of water and dissolved with 48 parts of sodium hydroxide; a mixture of 196 parts of acetic acid and 196 parts of water was further added to obtain a suspension of a coupling component. While agitating well the transparent diazo solution, the acetic acid suspension of the coupling component was added at a temperature of 15° C. within one hour and 30 minutes to two hours. After the coupling reaction was completed, a surface treatment was given using 45 parts of rosin and 13 parts of calcium chloride. The obtained pigment composition was filtered and rinsed to separate a wet pigment paste. The coagulation was dried at 90° C. to obtain a surface-treated pigment, C. I. Pigment Yellow 74 manufactured by SANYO COLOR WORKS, Ltd.

Synthesis of Master Batch

In a Henschel mixer manufactured by MITSUI MINING COMPANY, LIMITED, 1,200 parts of water, 540 parts of the colorant C. I. Pigment Yellow 74, 108 parts of Disperbyk-161 as a dispersant, having an amine value of 11 mg KOH/g, manufactured by BYK-Chemie GmbH and 1,200 parts of a polyester resin were added and mixed. After it was kneaded using a two-roll mill at a temperature of 150° C. over 30 minutes, the mixture was rolled, cooled and then pulverized with a pulverizer to obtain Master Batch 4.

Preparation of Oil Phase

In a vessel with a stirrer and a thermometer, 378 parts of Low-Molecular Polyester 2, 110 parts of carnauba wax and 947 parts of ethyl acetate were charged. After it was heated to 80° C. under agitation and maintained for five hours while keeping the temperature at 80° C., the mixture was cooled to 30° C. in one hour. Next, 500 parts of Master Batch 4 and 500 parts of ethyl acetate were charged in a vessel which was mixed for one hour to obtain Raw Material Solution 2.

In a vessel, 1,324 parts of Raw Material Solution 2 was transferred, and the colorant and the releasing agent were dispersed in three passes using a bead mill, Ultraviscomill manufactured by Aimex Co., Ltd., filled at 80% by volume with 0.5-mm zirconia beads under conditions of a liquid feeding rate of 1 kg/hr, a disk circumferential velocity of 6 m/sec. Next, 1,324 parts of 65-% ethyl acetate solution of Low Molecular Polyester 2 and eight parts of a copolymer Disperbyk-111 having an acid value of 129 mg KOH/g, manufactured by BYK-Chemie GmbH, was added, and the mixture was dispersed in a single pass under the same conditions as above to obtain Pigment-Wax Dispersion 2. Pigment-Wax Dispersion 2 had a solid concentration of 50% (130° C. and 30 minutes).

Emulsification and Desolvation

In a vessel, 749 parts of Pigment-Wax Dispersion 2, 115 parts of Prepolymer 2 and 2.9 parts of Ketimine Compound 2 were placed and mixed with T.K HOMO MIXER manufactured by Tokushu Kika Kogyo Co., Ltd. at 5,000 rpm for one minute. Then, 1,200 parts of Aqueous Phase 2 was added to the vessel, and the mixture was mixed with T.K HOMO MIXER at 13,000 rpm for 20 minutes to obtain Emulsified Slurry 2.

In a vessel equipped with an agitator and a thermometer, Emulsified Slurry 2 was introduced and desolvated at 30° C. for eight hours. Then, it was aged at 45° C. for four hours to obtain Dispersed Slurry 2. Dispersed Slurry 2 had a volume average particle diameter of 5.99 μm, a number average particle diameter of 5.70 μm, which were measured by Multisizer II available from Nikkaki Bios Co., Ltd.

Washing and Drying

After 100 parts of Dispersed Slurry 2 was filtered under a reduced pressure, 100 parts of ion-exchanged water was added to the filter cake, mixed with T.K., HOMO MIXER at 12,000 rpm for 10 minutes and then filtered. To the filter cake obtained, 10-% hydrochloric acid was added such that the pH of the mixture was adjusted to 2.8. The mixture was mixed with T.K HOMO MIXER at 12,000 rpm for 10 minutes and the filtered. The operation of adding 300 parts of ion-exchanged water to the filter cake obtained and mixing at 12,000 rpm for 10 minutes followed by filtration was repeated twice to obtain Filter Cake 2.

Filter Cake 2 was dried in a circulating air drier at 45° C. for 48 hours and then sieved with a 75-μm mesh sieve to obtain Toner 10.

### EXAMPLE 5

Toner 11 was obtained in the same manner as Example 4 except that Master Batch 5 prepared as described below was used instead of Master Batch 4 in Example 4.

Pigment Processing

In a 10-liter kneader, 500 parts of crude copper phthalocyanine blue having a purity of 95% was charged along with 2,000 parts of common salt and 550 parts of diethylene glycol. After the mixture was kneaded at 100° C. for four hours, the mixture was added with 25 parts of natural rosin and further mixed for 30 minutes. The mixture obtained was brought out in 10,000 parts of water and agitated at 80° C. until the common salt and diethylene glycol dissolved. After it was further added with 50 parts of 98-% sulfuric acid and agitated for one hour, the mixture was filtered and washed until it became neutral to obtain a pigment composition in a paste form. This was further dried and pulverized to obtain 490 parts of the surface-treated pigment composition, C. I. Pigment Blue 15:3 manufactured by Dainichiseika Color & Chemicals Mfg. Co.

Synthesis of Master Batch

In a Henschel mixer manufactured by MITSUI MINING COMPANY, LIMITED, 1,200 parts of water, 540 parts of the colorant C. I. Pigment Blue 15:3, 108 parts of EFKA-4080 as a colorant dispersant, having an amine value of 3.6 mg KOH/g to 4.1 mg KOH/g, manufactured by EEKA Chemicals BV, and 1,200 parts of a polyester resin were added and mixed. After it was kneaded using a two-roll mill at a temperature of 150° C. over 30 minutes, the mixture was rolled, cooled and then pulverized with a pulverizer to obtain Master Batch 5.

### EXAMPLE 6

Toner 12 was obtained in the same manner as Example 4 except that Master Batch 6 prepared as described below was used instead of Master Batch 4 in Example 4 and that Disperbyk-111 was not used.

Pigment Processing

After 20.0 parts of 2-amino-5-methylbenzene sulfonic acid was dispersed in 200 parts of water, 22.0 parts of 20-% hydrochloric acid was added. While maintaining the temperature at 0° C., 25.1 parts of a 30-% sodium nitrite solution was delivered by drops to obtain a diazo liquid. Next, 20.6 parts of hydroxynaphthoic acid was dispersed at 60° C. in 242 parts of water, and 11.5 parts of a 48-% sodium hydroxide solution was added to obtain a coupler solution. This coupler solution was cooled to 0° C., and the diazo liquid was delivered by drops into the coupler solution under agitation. After the coupling reaction was completed, the mixture was added with 40 parts of a 10-% solution of sodium salt of rosin and agitated for one hour to obtain a suspension.

In this suspension, a solution in which 18.6 parts of calcium chloride was dissolved in 70 parts of water was added, and the mixture was agitated for 60 minutes to complete a lake reaction. After the completion of the lake reaction, the mixture was agitated for one hour with heating at 80° C. to obtain an aqueous suspension of a calcium lake azo pigment. This suspension was filtered, and the coagulation was dried at 90° C. to obtain a surface-treated pigment, C. I. Pigment Red 57:1 manufactured by DAINIPPON INK AND CHEMICALS, INCORPORATED.

Synthesis of Master Batch

In a Henschel mixer manufactured by MITSUI MINING COMPANY, LIMITED, 1,200 parts of water, 540 parts of the C. I. Pigment Red 57:1, 108 parts of Disperbyk-2001 as a dispersant, having an amine value of 29 mg KOH/g and an acid value of 19 mg KOH/g, manufactured by BYK-Chemie GmbH, and 1,200 parts of a polyester resin were added and mixed. After it was kneaded using a two-roll mill at a temperature of 150° C. over 30 minutes, the mixture was rolled, cooled and then pulverized with a pulverizer to obtain Master Batch 6.

### COMPARATIVE EXAMPLE 7

Toner 13 was prepared in the same manner as Example 4 except that disperbyk-111 was not used in Example 4.

### COMPARATIVE EXAMPLE 8

Toner 14 was prepared in the same manner as Example 4 except that no surface treatment was given in Example 4.

### COMPARATIVE EXAMPLE 9

Toner 15 was prepared in the same manner as Example 4 except in Example 4 no surface treatment was given and that Disperbyk-111 was not used.

### COMPARATIVE EXAMPLE 10

Toner 16 was prepared in the same manner as Example 5 except that disperbyk-111 was not used in Example 5.

### COMPARATIVE EXAMPLE 11

Toner 17 was prepared in the same manner as Example 5 except that no surface treatment was given in Example 5.

### COMPARATIVE EXAMPLE 12

Toner 18 was prepared in the same manner as Example 5 except in Example 5 no surface treatment was given and that Disperbyk-111 was not used.

### COMPARATIVE EXAMPLE 13

Toner 19 was prepared in the same manner as Example 6 except that no surface treatment was given in Example 6.

<Evaluation Method and Evaluation Results>

The volume average particle diameter Dv and the number average particle diameter Dn of a toner were measured by means of COULTER COUNTER TA-II, manufactured by Coulter Electronics, Ltd., with an aperture diameter of 100 μm.

At a temperature of 28° C. and a relative humidity of 80%, 10 parts of each toner obtained was mixed with 100 parts of ferrite carrier, and the charge quantity of the toner was measured by the blow-off method. It was observed that the charge distribution at this time was sharp.

One part of silica, AEROSIL R972 manufactured by NIPPON AEROSIL CO., LTD., was added to 100 parts of a toner, and the mixture was mixed in a sample mill for one minute to obtain a toner having externally added silica. A solid color image was fixed without fuser oil for fixing using a remodeled electrophotographic full-color copying machine, imagio Neo 450 manufactured by Ricoh Company, Ltd. such that a toner of 1.0±0.1 mg/cm² was developed, and the turbidity was measured using a turbidity measuring apparatus. The lower turbidity indicates the higher transparency.

The results of these evaluations are shown in Table 2.

TABLE 2

| | Toner particle | | | Toner charge | | | |
|---|---|---|---|---|---|---|---|
| | distribution | | | quantity(−μC/g) | | | |
| | Dᵥ (μm) | Dₙ (μm) | Dᵥ/Dₙ | 5 sec. | 1 min. | 10 min. | Turbidity |
| Example 4 | 4.56 | 4.15 | 1.10 | 31.8 | 32.0 | 32.7 | 7 |
| Example 5 | 4.78 | 4.51 | 1.06 | 28.6 | 29.8 | 30.7 | 4 |
| Example 6 | 4.67 | 4.32 | 1.08 | 29.4 | 29.8 | 30.4 | 7 |
| Comparative Example 7 | 4.69 | 4.30 | 1.09 | 21.3 | 20.7 | 19.9 | 8 |
| Comparative Example 8 | 4.88 | 4.56 | 1.07 | 15.8 | 13.4 | 12.8 | 42 |
| Comparative Example 9 | 4.75 | 4.36 | 1.09 | 8.7 | 10.0 | 10.8 | 42 |
| Comparative Example 10 | 4.96 | 4.47 | 1.11 | 20.2 | 20.9 | 21.1 | 5 |
| Comparative Example 11 | 5.01 | 4.68 | 1.07 | 14.2 | 16.5 | 16.9 | 13 |
| Comparative Example 12 | 4.62 | 4.20 | 1.10 | 6.5 | 7.1 | 7.4 | 13 |
| Comparative Example 13 | 4.85 | 4.41 | 1.10 | 7.3 | 7.0 | 6.7 | 25 |

What is claimed is:

1. A toner comprising a binding resin, a colorant and a dispersant which disperses the colorant,
wherein the toner is produced in an aqueous medium,
the binding resin contains 50% by mass to 100% by mass of a polyester resin,
the colorant is a pigment whose surface is given an acid treatment, and
the acid value of the dispersant is 1 mg KOH/g to 30 mg KOH/g, and the amine value of the dispersant is 1 mg KOH/g to 100 mg KOH/g.

2. The toner according to claim 1, wherein the toner is produced by a dissolution and suspension method.

3. The toner according to claim 2, wherein the dissolution and suspension method comprises the steps of
dissolving or dispersing at least a component having an active hydrogen group, a polymer having a part which can react with active hydrogen, a colorant and a releasing agent in an organic solvent,
dispersing the solution or the dispersion into droplets in an aqueous medium to form an O/W dispersion, and
removing the organic solvent by reacting the polymer comprising the component having an active hydrogen group and a part which can react with active hydrogen in the O/W dispersion.

4. The toner according to claim 3, wherein the O/W dispersion comprises resin particles and the resin particles are adhered on the surface of the toner particles.

5. The toner according to claim 1, wherein the dispersant is mutually soluble with the binding resin.

6. The toner according to claim 1, wherein the mass average molecular weight of the dispersant is 2,000 to 100,000.

7. The toner according to claim 1, wherein the amount of the dispersant added is one part by mass to 50 parts by mass per 100 parts by mass of the colorant.

8. The toner according to claim 1, wherein the content of the dispersant in the toner is 0.1% by mass to 10% by mass.

9. The toner according to claim 1, wherein the colorant is at least any one type selected from C. I. Pigment Yellow 74, C. I. Pigment Yellow 93, C. I. Pigment Yellow 128, C. I. Pigment Yellow 139, C. I. Pigment Yellow 155, C. I. Pigment Yellow 180, C. I. Pigment Yellow 185, C. I. Pigment Red 57:1, C. I. Pigment Red 122, C. I. Pigment Red 146, C. I. Pigment Red 184, C. I. Pigment Red 185, C. I. Pigment Red 238, C. I. Pigment Red 269, C. I. Pigment Blue 15:3 and C. I. Pigment Blue 15:4.

10. The toner according to claim 1, wherein the toner comprises a releasing agent.

11. The toner according to claim 10, wherein the releasing agent has a melting point of 160° C. or less.

12. The toner according to claim 4, wherein the resin particles have an average particle diameter of 5 nm to 500 nm.

13. The toner according to claim 3, wherein the method for producing the toner in an aqueous medium uses a modified polyester resin which can react with active hydrogen, and a non-modified polyester resin, and the mass ratio of the modified polyester resin and the non-modified polyester resin is 5/95 to 75/25.

14. The toner according to claim 13, wherein the acid value of the modified polyester resin and the non-modified polyester resin is 0 mg KOH/g to 30 mg KOH/g.

15. The toner according to claim 3, wherein the mixing ratio of the colorant to the organic solvent is 5/95 to 50/50.

16. The toner according to claim 1, wherein the toner further comprises a copolymer having an acid value of 1 mg KOH/g to 180 mg KOH/g.

17. A developer comprising a toner,
wherein the toner is produced in an aqueous medium, and
the toner comprises a binding resin, a colorant and a dispersant that disperses the colorant,
wherein the binding resin contains 50% by mass to 100% by mass of a polyester resin;
the colorant is a pigment whose surface is given an acid treatment; and
the acid value of the dispersant is 1 mg KOH/g to 30 mg KOH/g, and the amine value of the dispersant is 1 mg KOH/g to 100 mg KOH/g.

18. The developer according to claim 17, wherein the developer is any one of a one-component developer and a two-component developer.

19. A toner container comprising a toner filled inside,
wherein the toner is produced in an aqueous medium, and
the toner comprises a binding resin, a colorant and a dispersant that disperses the colorant,
wherein the binding resin contains 50% by mass to 100% by mass of a polyester resin;
the colorant is a pigment whose surface is given an acid treatment; and
the acid value of the dispersant is 1 mg KOH/g to 30 mg KOH/g, and the amine value of the dispersant is 1 mg KOH/g to 100 mg KOH/g.

20. A process cartridge comprising:
a latent electrostatic image bearing member, and
a developing means which forms a visible image by developing with a toner a latent electrostatic image formed on the latent electrostatic image bearing member,
wherein the toner is produced in an aqueous medium, and
the toner comprises a binding resin, a colorant and a dispersant that disperses the colorant,
wherein the binding resin contains 50% by mass to 100% by mass of a polyester resin;
the colorant is a pigment whose surface is given an acid treatment; and
the acid value of the dispersant is 1 mg KOH/g to 30 mg KOH/g, and the amine value of the dispersant is 1 mg KOH/g to 100 mg KOH/g.

21. An image forming apparatus comprising: a latent electrostatic image bearing member, a latent electrostatic image forming means that forms a latent electrostatic image on the latent electrostatic image bearing member, a developing means that develops the latent electrostatic image using a toner and forms a visible image, a transferring means that transfers the visible image on a recording medium and a fixing means that fixes a transfer image transferred on the recording medium,
wherein the toner is produced in an aqueous medium, and
the toner comprises a binding resin, a colorant and a dispersant that disperses the colorant,
wherein the binding resin contains 50% by mass to 100% by mass of a polyester resin;
the colorant is a pigment whose surface is given an acid treatment; and
the acid value of the dispersant is 1 mg KOH/g to 30 mg KOH/g, and the amine value of the dispersant is 1 mg KOH/g to 100 mg KOH/g.

22. An image forming method comprising the steps of
forming a latent electrostatic image on a latent electrostatic image bearing member,
developing the latent electrostatic image using a toner to form a visible image,
transferring the visible image to a recording medium, and
fixing a transfer image transferred on the recording medium,
wherein the toner is produced in an aqueous medium, and
the toner comprises a binding resin, a colorant and a dispersant that disperses the colorant,
wherein the binding resin contains 50% by mass to 100% by mass of a polyester resin;
the colorant is a pigment whose surface is given an acid treatment; and
the acid value of the dispersant is 1 mg KOH/g to 30 mg KOH/g, and the amine value of the dispersant is 1 mg KOH/g to 100 mg KOH/g.
